(19) United States
(12) Patent Application Publication
(10) Pub. No.: US 2026/0275559 A1
(43) Pub. Date: Sep. 17, 2026

(54) APPARATUS AND METHOD FOR CONDUCTING ELECTROLYSIS AND ELECTRODE UNIT FOR SUCH AN APPARATUS

(71) Applicant: ATOTECH DEUTSCHLAND GMBH & CO. KG, Berlin (DE)

(72) Inventors: Sebastian Kühne, Berlin (DE); Jens Heydecke, Teltow (DE); Ulrich Laudien, Berlin (DE); Guido Klupsch, Zossen (DE)

(73) Assignee: ATOTECH DEUTSCHLAND GMBH & CO. KG, Berlin (DE)

(21) Appl. No.: 19/166,590

(22) PCT Filed: Apr. 24, 2024
(86) PCT No.: PCT/EP2024/061231

§ 371 Date: Sep. 18, 2025

(30) Foreign Application Priority Data
Apr. 25, 2023 (EP) 23169826.7

(51) Int. Cl. C25C 7/06; C25C 1/10; C25C 7/04

(52) U.S. Cl. CPC C25C 7/06; C25C 1/10; C25C 7/04

(57) ABSTRACT

An apparatus for conducting an electrolytic process includes: a container having a container interior for accommodating at least one electrolyte; an array of spaced-apart first electrodes, arranged in the container; at least one second electrode, arranged with at least part of a surface thereof exposed to at least part of the container interior for accommodating at least one of the at least one electrolytes; and a current supply system for causing electrical current to flow via the second electrode(s) and major surfaces of the first electrodes through the at least one electrolyte by establishing potential differences between major surfaces of the first electrode on the one hand and the second electrodes on the other hand, such that the first electrodes have an opposite polarity to the polarities of the second electrodes.

### TECHNICAL FIELD

The invention relates to an apparatus for conducting an electrolytic process, comprising:
a container having a container interior for accommodating at least one electrolyte;
an array of spaced-apart first electrodes, arranged in the container;
at least one second electrode, arranged with at least part of a surface thereof exposed to at least part of the container interior for accommodating at least one of the at least one electrolytes; and
a current supply system for causing electrical current to flow via the second electrode(s) and major surfaces of the first electrodes through the at least one electrolyte by establishing potential differences between major surfaces of the first electrode on the one hand and the second electrodes on the other hand, such that the first electrodes have an opposite polarity to the polarities of the second electrodes,
wherein the array of first electrodes includes at least one end electrode interposed between one of the second electrodes on the one hand and all of the other first electrodes of the array on the other hand, and
wherein, in addition to the end electrode(s), the array of first electrodes includes at least one first electrode other than an end electrode.

The invention also relates to a method of conducting an electrolytic process using an apparatus comprising:
a container having a container interior for accommodating at least one electrolyte;
an array of spaced-apart first electrodes, arranged in the container; and
at least one second electrode, arranged with at least part of a surface thereof exposed to at least part of the container interior for accommodating at least one of the at least one electrolytes,
wherein the array of first electrodes includes at least one end electrode interposed between one of the second electrodes on the one hand and all of the other first electrodes of the array on the other hand, and
wherein, in addition to the end electrode(s), the array of first electrodes includes at least one first electrode other than an end electrode,
wherein the method comprises:
providing the at least one electrolyte in the container; and
causing electrical current to flow via the second electrode(s) and major surfaces of the first electrodes through the at least one electrolyte by establishing potential differences between major surfaces of the first electrode on the one hand and the second electrodes on the other hand, such that the first electrodes have an opposite polarity to the polarities of the second electrodes.

The invention also relates to an electrode unit for use in an electrolytic process, comprising:
an array of electrodes, each in the form of a sheet comprising a mesh of electrically conductive material provided with at least one electrical contact point, arranged with major surfaces of neighbouring electrodes facing in each other's direction;
at least one electrical current feeder for electrically connecting at least one of the array of electrodes to an electrical current source external to the electrode unit; and
a plurality of electrical conductors, each connecting one of the electrical contact points to one of the electrical current feeders.

The invention also relates to an apparatus for conducting an electrolytic process comprising such an electrode unit.

### BACKGROUND ART

U.S. Pat. No. 5,156,730 discloses an electrode array that includes a plurality of individual electrode segments. The electrode segments are independently wired and physically separated from each other. Means are provided for electrically biasing each of the electrode segments individually and for controlling the quantity of current to each of the electrode segments individually. This provides for obtaining a selected area and configuration of a current profile of the electrode to thereby accommodate differently-sized and differently-shaped articles to be plated or etched. In the disclosed embodiment, anode segments are supported on an insulating rack. The anode array is presented in a planar format.

WO 02/053806 A2 discloses a device and method to enable large-surface substrates with relatively high resistance values to be provided with thin layers of largely homogeneous layer thickness by electrochemical deposition. A counter-electrode is divided into multiple electrode segments. Different voltage differentials can be applied between each individual electrode segment and a substrate to be coated. In the disclosed embodiment, electrode strips are fixed to a plastic plate. Metal rails that are guided upwards on the back of the plastic plate serve to provide electrical contact and are connected to the respective electrode strips by metal screws. When a homogeneous current density is realised across the substrate, the voltage generally increases from the uppermost segment electrode to the lowest. In an embodiment, each of the counter-electrode segments is controlled by its own voltage source, wherein one pole of this voltage source is connected to the respective counter-electrode segment and the other to the substrate to be counted. In an alternative embodiment, all counter-electrode segments are controlled by one voltage source and a suitable electrical resistance, adapted with regard to its electrical parameter, is connected between this voltage source and each individual counter-electrode segment.

WO 2022/263483 A1 discloses a method of oxidising manganese species in a treatment device. The device comprises at least one anode unit and at least one cathode. In one embodiment, the anode unit is a defined compartment comprising at least one anode in the centre of at least one anode unit. The anode is provided as a vertically oriented layer stack comprising a plurality of 8 to 20 anode layers, which are expanded metals having an individual surface factor of slightly above 2. The at least one anode unit is confined by a housing comprising at least one permeable barrier, which is a Nafion-type membrane. The distance between the plurality of anode layers is fixed by spacers. Cathodes are provided on opposite sides of the at least one anode unit. An electrical current is supplied to the at least one anode and the at least one cathode. The anodic current density is approximately 1 A/dm², whereas the cathodic current density is approximately 10 A/dm². The treatment device is filled with a catholyte consisting of aqueous phosphoric acid (70 wt.-%), wherein the liquid is continually pumped through the anode unit. While flowing through the anode unit, the liquid is in contact with the anode layers of the stack and manganese species having an oxidation number below +7 are continually re-oxidised to permanganate ions (i.e. a manganese species having the oxidation number +7).

In this type of device, there is a shielding effect in the stack of anode layers. This has two consequences. First, there is a higher current density on that side of each layer that is directed towards the nearest cathode than on the opposite side—the only exception is for an anode layer exactly at the centre of a symmetrical stack of course. Second, the current density at the outwardly-directed surface of the anode layer at the end of the stack proximal to the cathode is very much larger than that of any anode surface inside the stack. In principle, the number of reactions per unit current increases with the current density at low values. With the known device, the only way of increasing the efficiency of the anode layers inside the vertically-oriented layer stack is to increase the total current supply over all the anode layers, but this would result in even higher current densities at the outer surfaces and does not result in a proportional yield increase.

A different problem that may arise with anode layers with a surface factor of 2 is that the aim of providing them with a large effective surface area for a given volume means that they can be relatively thin and flexible. In particular if an electrolyte is pumped past them, the surfaces of neighbouring anode layers may touch and therefore spacers are required. Spacers at only selected points can be insufficient in number or size, because the anode layer may bulge. More spacers or spacers covering a larger surface will decrease the anode layer surface area, reducing the available effective surface area.

### SUMMARY OF INVENTION

It is first object of the invention to provide an apparatus and method of the types defined in the opening paragraphs that are more efficient in terms of the number of reactions per unit current.

It is a second, independent, object of the invention to provide an electrode unit and apparatus comprising such an electrode unit that allow for the use of relatively thin electrodes that are positioned close together and have a relatively high effective surface area.

The first object is achieved according to a first aspect by the apparatus according to the invention, which is characterised in that the apparatus is configured to establish potentials at the major surfaces of least the end electrode(s) that differ from those at the major surfaces of the first electrodes in the array other than the end electrode(s) by being closer to respective potentials of the second electrode(s).

The apparatus is based on the discovery that the number of reactions does not increase proportionally with the current density (electrical current per unit of geometric surface area) at the surface of any given first electrode, but levels off. This means that an increasing fraction of the electrical current flowing through the electrolyte via that first electrode flows through the electrolyte(s) without contributing to the desired electrolytic process. That fraction instead results in by-products (e.g. hydrogen and/or oxygen in case of an aqueous electrolyte). If the first electrodes in the array are all connected to the same rectifier circuit, as in the prior art, there will be a relatively large current flowing via the end electrode(s). Indeed, it has been found that about half the total electrical current passes through the end electrode(s) in such a set-up. The current density through the major surfaces of the end electrode(s) will thus be high. The current density at the major surfaces of the other first electrodes will be relatively low. Adding more first electrodes to the array will increase the yield, but only marginally. This is because the current density at the surfaces of each additional first electrode that is not an end electrode will be quite low. Increasing the total current will, it has been found, worsen the unequal current distribution, worsening the overall efficiency. Because, by contrast, the apparatus according to the invention is configured to establish potentials at the major surfaces of least the end electrode(s) that differ from those at the major surfaces of the first electrodes in the array other than the end electrode(s) by being closer to potentials of the second electrode(s), the current distribution over the first electrodes is changed relative to a situation in which the respective potentials at interconnects between the current supply system and the major surfaces of the respective first electrodes all have the same value. The change is such as to decrease the current flowing via the end electrode(s) as a fraction of the total current flowing via all first electrodes in the array. Thus, by allowing the currents flowing via the respective first electrodes to be more equal, more of the first electrodes can be operated at current levels close to but below the level at which the efficiency starts to level off. The distribution of currents over the first electrodes in the array is closer to the optimum, in which there are no longer a few electrodes (principally the end electrodes) with high current density and low yield and many first electrodes with very low current density and thus high relative yield, but a small absolute yield.

The apparatus is an apparatus for conducting an electrolytic process, which may in particular, but not exclusively, include a process of electrolytic oxidation of ions such as manganese species. Alternatives include electrochemical water splitting to obtain hydrogen, electroplating, electrorefining and plating out ion species (e.g. copper) from solutions, for example. The apparatus comprises a container for accommodating at least one electrolyte. The container need not be closed in all embodiments. The container may be arranged to accommodate more than one electrolyte having different respective compositions, in particular a catholyte and an anolyte, which are separated such as to prevent equalising of the respective compositions. The apparatus may be configured for at least one of the at least one electrolytes to flow through the container, in use, e.g. by being provided with at least one inlet and at least one outlet allowing at least one of the at least one electrolytes to flow through the container.

The apparatus comprises an array of spaced-apart first electrodes, arranged in the container. The spacing allows electrolyte to be accommodated in the spaces between facing sides of neighbouring first electrodes. The spaces need not be empty. It is sufficient if the spacing is such that neighbouring first electrodes are electrically isolated from each other, but for any electrolyte in the spaces between them. The result is an apparatus that is relatively compact but presents a large total effective first electrode surface area.

The first electrodes will generally be electrodes having opposing major surfaces. In the array of first electrodes, each end electrode interposed between a second electrode and all of the other first electrodes has one major surface facing that second electrode and one major surface facing a major surface of a neighbouring one of the other first electrodes. The opposing major surfaces of those first electrodes in the array that are interposed between other first electrodes each face a major surface of a respective neighbouring first electrode.

The electrodes may be generally in the form of sheets, e.g. liquid-permeable sheets, having a thickness several times smaller than their extent in the remaining two dimensions. The thickness is the distance between the two sides of the first electrodes just referred to, i.e. the sides of which at least one faces one of the two sides of a neighbouring first electrode in the array. The major surfaces are the surfaces on these two sides. The thickness of each first electrode may be in the order of micrometres, e.g. in the range of 1-2 μm. The spacing between the first electrodes in the array may be in the order of 0.5-5 mm, e.g. 1-3 mm. The first electrodes may also each comprise a respective array or lattice of electrically interconnected bars, e.g. arranged to define an overall sheet shape, for example by lying in a common plane.

The first electrodes may be plate-shaped, though not necessarily self-supporting and not necessarily or even preferably impervious to liquid. When plate-shaped, they are thus arranged in a stack, although not necessarily or even preferably oriented horizontally. Alternatively, the first electrodes may be configured cylindrically, e.g. circle-cylindrically, and arranged surrounding each other, e.g. concentrically. The first electrodes may be rigid or relatively flexible, in which case they are mounted such as to avoid contact between the facing sides of neighbouring first electrodes. One or more spacers between facing sides of neighbouring first electrodes may be provided to this end.

The apparatus comprises at least one second electrode. There may, for example, be one second electrode on each side of the array of first electrodes, each of these second electrodes having one major surface facing a proximal major surface of a respective one of the at least two end electrode(s). Alternatively, there may be a single such second electrode. The second electrode(s) may conform in shape to at least the proximal end electrode(s). That is to say, if the first electrodes are planar, then the second electrode(s) is or are also planar. If the first electrodes are curved, then the second electrode(s) is or are curved with a curvature of the same sign as that of the curvatures of the first electrodes, e.g. with a same radius of curvature. It is noted, however, that the first electrodes in the array need not all have the same shape (seen in plan view looking onto a major surface), size or mesh or apertures size.

In an embodiment, the array of first electrodes is an array of vertically arranged first electrodes. That is to say, that the direction of progression from one first electrode to the next is predominantly in a horizontal direction. The first electrodes are arranged in an upright orientation. The normals to the major surfaces of the first electrodes are mainly oriented in a horizontal direction.

The apparatus comprises a current supply system for causing electrical current to flow via the second electrode(s) and major surfaces of the first electrodes through the at least one electrolyte by establishing potential differences between interconnects to major surfaces of the first electrodes on the one hand and interconnects to each of the second electrodes on the other hand, such that the first electrodes have an opposite polarity to the polarities of the second electrodes. The terms first electrode and second electrode are thus used here to distinguish between electrodes having opposite polarities in use. The first electrodes may in particular be anodes and the second electrodes cathodes. The interconnects to major surfaces of the first electrodes are the one or more parts electrically interconnecting the current supply system to the major surfaces of the first electrodes. The one or more parts of an interconnect to a first electrode may include a part integral to the first electrode, as will be explained further below with reference to a particular embodiment. The current supply system will generally comprise at least one current source connected to at least one of the first electrodes, wherein the value of the current supplied or drawn by each current source is set separately from the value of the current of the other current sources, but each current source sets only the total current flowing via all the first electrodes connected to that current source. Those first electrodes are arranged in parallel respective circuit branches connected in series to that current source. Each current source may comprise its own respective current rectifier if the apparatus is arranged to be powered by an alternating current supply or three-phase current supply at the site at which the apparatus is installed.

The array of first electrodes includes at least one end electrode interposed between one of the second electrodes on the one hand and all of the other first electrodes of the array on the other hand. If the array is placed between two second electrodes, there will be two end electrodes. If there is only one second electrode, the first electrode proximate to that second electrode will be the end electrode.

The apparatus is configured to establish potentials at the major surfaces of least the end electrode(s) that differ from those at the major surfaces of the first electrodes in the array other than the end electrode(s) by being closer to respective potentials of the second electrode(s). The potential may vary across each major surface with distance from the interconnect(s) between the power supply system and that major surface, however. The potential difference between major surfaces referred to is at least between corresponding locations at corresponding major surfaces, where corresponding surfaces correspond in the sense of facing in the same direction and locations correspond in the sense of being aligned in the direction in which the first electrodes are arranged in the array. Generally, however, the potential differences between first electrodes will be larger than those across a major surface of any particular first electrode. The opposite major surfaces of any particular first electrode may be, but need not be, at the same potential at corresponding locations. The major surfaces of several or all of the first electrodes other than the end electrodes may be at the same potential or at different respective potentials.

In an embodiment, in addition to the end electrode(s), the array of first electrodes includes at least two first electrodes other than an end electrode, and the apparatus is configured to establish potentials at the major surfaces of these at least two other first electrodes that differ from one first electrode to the next such that a differential to a potential of a most proximal one of the at least two second electrodes increases according to how many of the first electrodes are interposed between the first electrode and the most proximal second electrode.

It is thus possible to equalise the respective currents flowing via the individual first electrodes even further. In particular, the electrical current values can all be brought up to or just below a level at which the efficiency starts to decrease. If there are two second electrodes and the array of first electrodes is placed in between facing surfaces of the second electrodes, there will be two end electrodes in the array. The apparatus will then be configured to establish potentials at the major surfaces of the other first electrodes that increase from the end electrode to the one or two electrodes in the middle of the array and then decrease again. This is because the most proximal second electrode will be a different one for the first electrodes in one half of the array from the one for the first electrodes in the other half of the array. The distribution of currents is such that the current density at the major surfaces of the first electrodes are approximately equal, in particular close to the optimum current density value. If there is only one second electrode, there will be only one end electrode. The apparatus will then be configured to establish potentials at the major surfaces of the other first electrodes that increase from the end electrode to the first electrode at the opposite end of the array, this being the one having the most first electrodes interposed between itself and the (only) end electrode. It is noted that there may be potential differences between the two major surfaces of any one of the first electrodes. These will be smaller than if the first electrodes were all to be connected in parallel to each other and collectively in series to a single current source, however. Generally, such differences will be negligible.

In an embodiment of the apparatus, the current supply system comprises at least two electrical current sources, each electrically connected in series via respective electrical current feeders to respective disjoint sub-sets of the first electrodes in the array.

That is to say that each electrical current source is connected in series to an associated respective sub-set of first electrodes only, wherein the sub-sets are disjoint sub-sets. In set theory in mathematics and formal logic, two sets are said to be disjoint sets if they have no element in common.

The electrical current sources may be controllable current sources, allowing the current supplied to the respective sub-sets of the first electrodes to be controlled to achieve a set value. In any case, the current sources allow for separate current supply, the values of the total currents supplied to the respective sub-sets being different for at least two, e.g. all current sources, and set individually for each current source. One or more of the sub-sets may be formed by only a single first electrode. It is possible to implement the overall concept of establishing potentials at the major surfaces of at least the end electrode(s) that differ from those at the major surfaces of first electrodes in the array other than the end electrodes using only a plurality of electrical current sources. If this is done for each first electrode in the array, then, in the case of a symmetric arrangement with two second electrodes on either side of the array of first electrodes, each of the sub-sets may include two first electrodes, symmetrically arranged with respect to the middle of the array. Otherwise, there would generally be one first electrode in each sub-set. It is also possible to have larger sub-sets, in particular if the overall concept behind the apparatus is also realised using pre-resistors. Each current source may comprise at least one voltage rectifier particular to that current source, i.e. not shared with the other current sources. It is also possible for current sources to share a voltage rectifier, but to have their own respective DC/DC-converter allowing for independent current supply to the sub-set of first electrodes connected to that current source. For apparatus to be used in a plant having a Direct Current microgrid, there will be no voltage rectifier, of course. In the present context, a current feeder is an electrically interconnecting part or group of parts, i.e. one or more electrical conductors. There may be more than one current feeder for one or each combination of current source and sub-set of first electrodes. Current feeders will not be shared between such combinations. The current feeders extend through the container interior. The current feeders are electrically connected to the current sources via conductors such as wires extending to outside the container.

In an embodiment of the apparatus, at least two of the first electrodes are connected electrically in series with a common electrical current source comprised in the current supply system, pre-resistors are arranged electrically between the major surfaces of the first electrodes electrically connected to the common electrical current source, and total resistance values of the pre-resistors between the common electrical current source and the first electrodes connected to the common electrical current source differ between the first electrodes connected to the common electrical current source such as to decrease according to how many of the first electrodes are interposed in the array between the first electrode and a most proximal one of the at least one second electrodes.

This is another way of realising the concept of establishing potentials at the major surfaces of at least the end electrode(s) that differ from those at the major surfaces of the first electrodes in the array other than the end electrode by being closer to respective potentials of the second electrodes. In particular, this embodiment allows the potential to differ from one first electrode to the next throughout the array without using a current supply system with very many separate current sources. The potential difference to the nearest second electrode is highest for the first electrode furthest away from that second electrode. The common electrical current source can only be configured or controlled to supply or draw a particular total value of current to, respectively from, all the first electrodes connected to that common electrical current source. Equalisation between the individual first electrodes is achieved by means of the pre-resistors. As mentioned, this embodiment can be combined with the embodiment using multiple separate current sources.

In a particular example of this embodiment, the first electrodes connected electrically in series with a common electrical current source are connected in a parallel circuit with respect to each other and the pre-resistors are arranged in respective branches of the parallel circuit in which the first electrodes are comprised, so that the total resistance values of the pre-resistor differ between the branches such as to decrease according to how many of the first electrodes are interposed in the array between the first electrode in the branch and a most proximal one of the at least one second electrodes.

This example is relatively easy to design and implement with the appropriate resistance values of the pre-resistors.

In a particular example of the embodiment of the apparatus in which at least two of the first electrodes are connected electrically in series with a common electrical current source comprised in the current supply system, pre-resistors are arranged electrically between the major surfaces of the first electrodes electrically connected to the common electrical current source, and total resistance values of the pre-resistors between the common electrical current source and the first electrode differ between the first electrodes connected to the common electrical current source such as to decrease according to how many of the first electrodes are interposed in the array between the first electrode and a most proximal one of the at least one second electrodes, the first electrodes are provided in the form of sheets, comprising at least a major section defining the major surfaces, and the sheet forming at least one of the first electrodes further comprises at least one section forming one of the pre-resistors and interconnecting the major section with at least one contact point electrically connecting the first electrode to a remainder of the circuit in which the first electrode is comprised.

Thus, the pre-resistors are in effect integrated into the first electrodes. This results in a compact arrangement that is relatively simple to manufacture. The section forming one of the pre-resistors may, for example, be cut into the sheet in the form of a path from the contact point to the major section, this path lying in the same plane when the sheet is arranged in planar form. In the present context, the term sheet is used merely to indicate that the lateral dimensions of the two opposing major surfaces are much larger than a thickness corresponding to the dimension between the two opposing major surfaces. A sheet may be permeable to liquid, need not have a rectangular outline or be flexible to the extent that the sheet could, for example, be rolled up.

An example of any embodiment of the apparatus in which at least two of the first electrodes are connected electrically in series with a common electrical current source comprised in the current supply system, pre-resistors are arranged electrically between the major surfaces of the first electrodes electrically connected to the common electrical current source, and total resistance values of the pre-resistors between the common electrical current source and the first electrode differ between the first electrodes connected to the common electrical current source such as to decrease according to how many of the first electrodes are interposed in the array between the first electrode and a most proximal one of the at least one second electrodes, further comprises at least one pre-resistor formation, wherein the pre-resistor formation is provided with at least one first electrical contact point electrically connected to an electrical current source comprised in the current supply system and with a plurality of second electrical contact points, wherein at least two of the second electrical contact points are electrically connected to different respective first electrodes, and wherein current paths of different electrical resistance are formed in the pre-resistor formation between at least one of the at least one first electrical contact points and second electrical contact points electrically connected to different respective first electrodes.

This example can be implemented without substantial modification of existing first electrode designs, other than to provide connections to the second electrical contact points. The pre-resistor formation will generally be a shaped contiguous mass of one or more electrically conducting materials. Suitable materials include titanium, for example. The formation need not be self-supporting and may in principle have any shape. The formation may be formed by moulding, cutting, e.g. laser cutting, milling, welding, soldering or any combination, for example. Sections of the current paths may be shared between current paths.

It would alternatively be possible to use commonly available resistors arranged out of contact with the electrolyte and connected to the respective first electrodes, but this would involve additional interconnects.

In a particular example of any version of the embodiment of the apparatus in which at least two of the first electrodes are connected electrically in series with a common electrical current source comprised in the current supply system, pre-resistors are arranged electrically between the major surfaces of the first electrodes electrically connected to the common electrical current source, total resistance values of the pre-resistors between the common electrical current source and the first electrodes differ between the first electrodes connected to the common electrical current source such as to decrease according to how many of the first electrodes are interposed in the array between the first electrode and a most proximal one of the at least one second electrodes, the apparatus further comprises at least one pre-resistor formation, the pre-resistor formation is provided with at least one first electrical contact point electrically connected to an electrical current source comprised in the current supply system and with a plurality of second electrical contact points, at least two of the second electrical contact points are electrically connected to different respective first electrodes, and current paths of different electrical resistance are formed in the pre-resistor formation between at least one of the at least one first electrical contact points and second electrical contact points electrically connected to different respective first electrodes, each of at least one of the first electrodes is electrically connected to at least two of the second electrical contact points through respective electrical conductors connected to spaced-apart electrical contact points of that first electrode.

This embodiment reduces voltage differentials across the major surfaces of that first electrode. There is thus a more uniform distribution of the current density of the electrical current passing between the electrolyte and those surfaces. Furthermore, the more electrical conductors are used, the lower is the amount of ohmic heating of each individual conductor. Separating them also allows for more effective cooling by heat conduction, e.g. through the electrolyte.

In a particular example of any version of the embodiment in which at least two of the first electrodes are connected electrically in series with a common electrical current source comprised in the current supply system, pre-resistors are arranged electrically between the major surfaces of the first electrodes electrically connected to the common electrical current source, total resistance values of the pre-resistors between the common electrical current source and the first electrodes differ between the first electrodes connected to the common electrical current source such as to decrease according to how many of the first electrodes are interposed in the array between the first electrode and a most proximal one of the at least one second electrodes, the apparatus further comprises at least one pre-resistor formation, the pre-resistor formation is provided with at least one first electrical contact point electrically connected to an electrical current source comprised in the current supply system and with a plurality of second electrical contact points, at least two of the second electrical contact points are electrically connected to different respective first electrodes, and current paths of different electrical resistance are formed in the pre-resistor formation between at least one of the at least one first electrical contact points and second electrical contact points electrically connected to different respective first electrodes, the pre-resistor formation comprises a sheet with mutually separated current paths formed therein, wherein the current paths of different electrical resistance differ in terms of at least one of length and cross-sectional area perpendicular to a direction of progression of the current path along the length of the current path.

The term sheet is again used merely to indicate that the lateral dimensions of opposing major surfaces of the formation are much larger than a thickness corresponding to the dimension between the two opposing major surfaces. A sheet need not have a rectangular outline or be flexible to the extent that the sheet could, for example, be rolled up. In particular, the formation may be a foil, a plate or a layer supported on a substrate, for example. The cross-sectional area can be made to differ only due to differences in width of the current path, the height corresponding to a thickness of the sheet. In that case the sheet may have a uniform thickness. The current paths may be obtained by cutting, e.g. laser-cutting, the outlines of the current paths from a sheet initially having a boundary that is a convex curve in the geometric sense (e.g. a rectangular sheet). This embodiment can thus be obtained relatively easily. A material composition of the formation may be uniform, for example. The length of the current path may correspond to the length of the neutral axis thereof. Variation of the lengths of the current paths may be the predominant way in which the different electrical resistances are set. Variation of the width and/or height may be reserved for fine-tuning.

In a particular example of any version of the embodiment in which at least two of the first electrodes are connected electrically in series with a common electrical current source comprised in the current supply system, pre-resistors are arranged electrically between the major surfaces of the first electrodes electrically connected to the common electrical current source, total resistance values of the pre-resistors between the common electrical current source and the first electrode differ between the first electrodes connected to the common electrical current source such as to decrease according to how many of the first electrodes are interposed in the array between the first electrode and a most proximal one of the at least one second electrodes, the apparatus further comprises at least one pre-resistor formation, the pre-resistor formation is provided with at least one first electrical contact point electrically connected to an electrical current source comprised in the current supply system and with a plurality of second electrical contact points, at least two of the second electrical contact points are electrically connected to different respective first electrodes, and current paths of different electrical resistance are formed in the pre-resistor formation between at least one of the at least one first electrical contact points and second electrical contact points electrically connected to different respective first electrodes, the pre-resistor formation comprises a sheet with mutually separated current paths formed therein, and the current paths of different electrical resistance differ in terms of at least one of length and cross-sectional area perpendicular to a direction of progression of the current path along the length of the current path, the pre-resistor formation is interposed between two of the first electrodes in the array.

This results in a particularly compact assembly with short electrical connections between the second electrical contact points and the respective first electrodes.

In particular version of this embodiment, at least one of the second electrical contact points is electrically connected to a first electrode via an electrical conductor passing through at least one other of the first electrodes, e.g. an electrical conductor arranged in a bushing passing through the other first electrodes through which the conductor passes, which bushing is made of material having a lower electrical conductivity than the electrical conductor.

The bushing(s) is, respectively are, thus electrically insulating, so that the surface potentials of the first electrodes can be maintained at different values. The bushings are made of material selected to withstand the electrolyte, which need not necessarily be the case for standard wiring. Standard first electrode designs can be used, because it is only necessary to provide them with apertures through which the conductors and bushings can pass.

In an example of any embodiment in which at least two of the first electrodes are connected electrically in series with a common electrical current source comprised in the current supply system, pre-resistors are arranged electrically between the major surfaces of the first electrodes electrically connected to the common electrical current source, total resistance values of the pre-resistors between the common electrical current source and the first electrode differ between the first electrodes connected to the common electrical current source such as to decrease according to how many of the first electrodes are interposed in the array between the first electrode and a most proximal one of the at least one second electrodes, the apparatus further comprises at least one pre-resistor formation, the pre-resistor formation is provided with at least one first electrical contact point electrically connected to an electrical current source comprised in the current supply system and with a plurality of second electrical contact points, at least two of the second electrical contact points are electrically connected to different respective first electrodes, and current paths of different electrical resistance are formed in the pre-resistor formation between at least one of the at least one first electrical contact points and second electrical contact points electrically connected to different respective first electrodes, the pre-resistor formation is at least partly covered by a housing made of material having a lower electrical conductivity than material of the pre-resistor formation.

The housing is electrically insulating, so that there are no or limited leakage currents from the pre-resistor formation to, for example, the second electrodes. The pre-resistor formation can thus be partly or completely immersed in the electrolyte, in use. The housing may, but need not, touch the pre-resistor formation. There may be a gap in between.

In an embodiment of the apparatus, the first electrodes are provided in the form of liquid-permeable sheets.

The first electrodes can therefore have a relatively high effective surface area in relation to their volume. The sheets may, for example, have a surface factor of 1 or higher, e.g. 1.4 or more, 1.7 or more, or even 2 or more or 2.2 or more, where surface factor denotes a parameter corresponding to the total effective surface area per geometric area. The sheets may be a foam or mesh, including a lattice, or a laminate of such sheets, for example. A further effect of this embodiment is that current paths through the electrolyte between the first electrodes other than the end electrode(s) and the second electrode(s) can be shorter.

In an example of this embodiment, at least two neighbouring first electrodes are separated from each other by at least one spacer.

The first electrodes need therefore not be very rigid. Their effective surface area can therefore be relatively high in relation to their volume. The spacers ensure on the one hand that the surfaces remain accessible. On the other hand, where the spacers are made of material having a lower electrical conductivity than that of material from which the first electrodes, in particular the sheets, are made, the spacers allow the surfaces of the neighbouring first electrodes to be maintained at different potentials. Thus, the spacer or spacers may be electrically insulating.

In an example of any embodiment in which the first electrodes are provided in the form of liquid-permeable sheets, the sheets comprise meshes.

This embodiment represents an easy way of providing first electrodes with a relatively high surface factor. The mesh may be woven, knitted, welded, sintered, etched or electroformed, for example. The strands of material making up the mesh may be, but need not be separate or intertwined, therefore. In a particular embodiment, the meshes are made of expanded metal. The apertures in such meshes may have the shape of a rhombus or rhomboid, for example. The strands of the meshes may be coated.

In an example of any embodiment in which the first electrodes are provided in the form of liquid-permeable sheets, at least two neighbouring first electrodes are separated from each other by at least one spacer and the sheets comprise meshes, the spacer comprises a thread of material having a lower electrical conductivity than material from which the meshes are made, and the thread is threaded through at least one of the meshes comprised in the neighbouring first electrodes in the form of a sequence of stitches.

This example allows for contact between neighbouring first electrodes to be avoided even where the meshes are relatively flexible. At the same time, the area covered by the spacer or spacers is relatively low. Assembly is relatively easy, since there is no need to attach a large number of separate spacer elements using individual fasteners. The thread may have a diameter in the order of mm, e.g. in the range of 0.5-5 mm, more particularly in the range of 0.5-2 mm. Having a lower electrical conductivity than material from which the meshes are made, the thread is effectively electrically insulating.

In an embodiment of the apparatus, the first electrodes comprise at at least their surfaces, e.g. only in surface coatings, at least one of lead, tantalum, a platinum group metal or an alloy or oxide thereof, e.g. at least one of platinum, a platinum alloy or platinum oxide.

Platinum group metals further include the iridium group metals of osmium, ruthenium and iridium, which are suitable together with platinum or as an alternative to platinum, as is lead. These are all relatively expensive and their function is generally to enable a catalyst in the electrolyte around the first electrodes to function optimally. Therefore, only providing them in surface coatings can be useful. If provided as a surface coating, such a coating may have a thickness in a range of between 0.5 and 50 μm, e.g. in a range of between 0.5 and 40 μm, or even in a range of 0.5-2 μm, for example. In particular platinum forms a thin platinum oxide layer when the first electrodes are used as anodes. It has been found that a loss of the platinum can occur, in particular at high current density values, leading to islands devoid of platinum and an overall decrease in performance. The effect is to a certain extent self-amplifying, because the current density increases where the islands are formed. There is, however, a threshold current density below which the loss of platinum is not such as to cut short the useful lifetime of the electrode to an unacceptable extent. The configuration of the apparatus, in particular the measures that allow the current passing through the first electrodes to be made more uniform, allow all or nearly all of the first electrodes to be operated below the threshold without rendering the first electrodes situated far from the end electrodes useless.

Oxides, e.g. iridiumoxide and/or tantalumoxide, can be used in applications in which organic matter in waste water is oxidised.

Where the first electrodes function as cathodes, e.g. in a process for removing copper from the electrolyte, the first electrodes may comprise at least copper at at least their surfaces, e.g. only in surface coatings.

In an embodiment of the apparatus, the first electrodes are mainly made of inert material, e.g. material comprising at least one of titanium, niobium and carbon.

The material can be selected for the ability of the material to withstand the electrolyte over prolonged periods of use, compatibility with a chosen coating, price, suitability for manufacturing as a mesh, e.g. of expanded metal, and the like. A particular example is a niobium electrode coated with platinum.

In an embodiment of the apparatus the array of first electrodes is at least partially enclosed by a housing, the second electrode(s) is or are arranged outside the housing, and the housing comprises at least one permselective membrane separating an interior of the housing from an exterior of the housing.

The housing may enclose the array of first electrodes up to a level of electrolyte present, in use, in the container outside the housing, for example. In this embodiment, reaction products obtained at the first electrodes cannot migrate and be converted back at one of the second electrodes. The membrane or membranes is, respectively are, effective as a barrier to reaction products obtained at the first electrodes, in use. This embodiment also potentially allows for the use of different electrolytes, e.g. a catholyte and an anolyte, having different respective compositions. The permselective membrane will then be configured to form a barrier for at least one ion species present in one of the electrolytes but not in the other. It is thus possible to include e.g. a catalyst, such as silver ions, in only one of the electrolytes. It is also possible to circulate only one of the electrolytes, e.g. where this electrolyte comprises a solution to be electrochemically re-generated such as an etching solution comprising manganese species to be electrochemically re-oxidised. The membrane may, for example, only be permeable to cations (such as hydrogen ions). A suitable membrane material includes, for example, nafion (a sulfonated tetrafluoroethylene-based fluoropolymer-copolymer).

In a particular example of this embodiment, therefore, but for the at least one permselective membrane(s), the housing is arranged to provide a separation of liquid in an interior of the housing from the exterior of the housing.

In an alternative embodiment of the apparatus, the array of first electrodes is at least partially enclosed by a housing arranged to provide a separation of liquid in an interior of the housing from an exterior of the housing, and the at least one second electrodes are attached to the housing such that at least one section of each of the second electrodes is exposed to the interior of the housing.

In this case, there can be only one electrolyte, e.g. a circulating solution to be re-generated by electrochemical oxidation. Because the effective surface area of the first electrodes is much larger than the exposed surface of the second electrodes, the reaction products obtained at the first electrodes do not all migrate to the second electrodes to be converted back, in particular if the electrolyte is circulated or otherwise passed through the interior of the housing. This embodiment has the further effect of keeping the volume of the container interior available to the electrolyte relatively low compared to the volume of the first electrodes and the effective surface area available at the first electrodes. The housing is or may be the container.

In an example of any embodiment in which either: (i) the array of first electrodes is at least partially enclosed by a housing, the second electrode(s) is or are arranged outside the housing, the housing comprises at least one permselective membrane separating an interior of the housing from an exterior of the housing and, but for the at least one permselective membrane(s), the housing is arranged to provide a separation of liquid in an interior of the housing from the exterior of the housing; or (ii) the array of first electrodes is at least partially enclosed by a housing arranged to provide a separation of liquid in an interior of the housing from an exterior of the housing, and the at least one second electrodes are attached to the housing such that at least one section of each of the second electrodes is exposed to the interior of the housing, the apparatus further comprises a liquid-conducting circuit comprising a pump for passing electrolyte through the interior of the housing, the circuit comprising at least one inlet conduit and at least one outlet conduit extending outside the housing.

This embodiment is suitable for use in re-generating solutions such as etching solutions, e.g. by electrochemically oxidising at least one constituent of the solution, or for plating out one or more constituents of a processing solution, for example. The circuit may comprise a reservoir. The circuit need not be closed. The inlet and outlet conduit may extend through a further part of an interior of the container, e.g. a further part for accommodating at least one of the at least one electrolytes, and through a wall of the container.

In an embodiment of the apparatus, at least one of the at least one end electrodes is separated from a proximal one of the at least one second electrodes by a distance plate provided with liquid-permeable windows.

The windows provide a path for electric current through the at least one electrolyte between the first electrodes and the second electrode. The distance plate allows the path to be relatively short without risk of short-circuit. The first and/or second electrodes can be relatively flexible. The distance plate holds any such flexible parts apart, even in the face of pressure differentials that might otherwise lead to contact due to bulging of the flexible part or parts. The second electrode, distance plate and first electrode may in particular be assembled into a cell forming a unit by being mounted to each other directly or via a supporting frame or housing.

In an example in which this embodiment is combined with any embodiment in which the array of first electrodes is at least partially enclosed by a housing, the second electrode(s) is or are arranged outside the housing, and the housing comprises at least one permselective membrane separating an interior of the housing from an exterior of the housing, the at least one permselective membranes is, respectively are arranged in or over the windows.

There may thus be a single membrane arranged over multiple windows or discrete membranes arranged in the windows. In either case, the second electrode can be placed particularly close to the array of first electrodes without reaction products formed at the first electrodes reaching the second electrode.

According to a second aspect, the first of the two objects mentioned above is solved by the method of conducting an electrolytic process according to the invention, which is characterised in that the step of causing electrical current to flow comprises establishing potentials at the major surfaces of least the end electrode(s) that differ from those at the major surfaces of the first electrodes in the array other than the end electrode(s) by being closer to respective potentials of the second electrode(s).

The method may use an apparatus according to a first aspect of the invention, just as the apparatus may be suitable for use in the method according to the second aspect of the invention.

The method allows to avoid that a very large electrical current is caused to flow through the electrolyte(s) via the major surface of each end electrode that is directed towards a second electrode. Instead, this current is made more equal to the electrical currents flowing via the major surfaces of the other first electrodes. The potentials at the major surfaces of least the end electrode(s) differ from those at the major surfaces of the first electrodes in the array other than the end electrode(s) at corresponding locations. There may be a gradient over any of the major surfaces. The opposite major surfaces of any particular first electrode may be, but need not be, at the same potential at corresponding locations.

In an embodiment of the method, in addition to the end electrode(s), the array of first electrodes includes at least two first electrodes other than an end electrode, and the step of causing electrical current to flow comprises establishing potentials at the major surfaces of these at least two other first electrodes that differ from one first electrode to the next such that a differential to a potential of a most proximal one of the at least two second electrodes increases according to how many of the first electrodes are interposed between the first electrode and the most proximal second electrode.

In this embodiment, it is possible to equalise the respective currents flowing via the individual first electrodes even further. In particular, they can all be brought up to or just below a level at which the efficiency starts to decrease. If there are two second electrodes and the array of first electrodes is placed in between facing surfaces of the second electrodes, there will be two end electrodes in the array. The method will then involve establishing potentials at the major surfaces of the other first electrodes that increase from the end electrode to the one or two electrodes in the middle of the array and then decrease again. This is because the most proximal second electrode will be a different one for the first electrodes in one half of the array from the one for the first electrodes in the other half of the array, assuming a symmetrical arrangement, assuming the spacing between the second electrodes and the respective end electrodes is the same. If there is only one second electrode, there will be only one end electrode. The method will then involve establishing potentials at the major surfaces of the other first electrodes that increase from the end electrode to the first electrode at the opposite end of the array, this being the one having the most first electrodes interposed between itself and the (only) end electrode. Again, it is noted that there may be potential differences between the two major surfaces of any one of the first electrodes. These will be smaller than if the first electrodes were all to be connected in parallel to each other in series to a single current source, however.

In an embodiment of the method the step of causing electrical current to flow comprises feeding separate electrical currents between at least two electrical current sources and respective disjoint sub-sets of the first electrodes in the array.

That is to say that separate currents are each fed to only a particular respective sub-set of the first electrodes, wherein the sub-sets are disjoint sub-sets. In set theory in mathematics and formal logic, two sets are said to be disjoint sets if they have no element in common. One current is fed to one of the disjoint sub-sets only, a further current is fed to another one of the disjoint sub-sets only, and so on.

These currents may be controlled to have particular respective value using controllable current sources. Alternatively, the values may be relatively uniform as a result of the configuration of the current sources, the layout of the apparatus and the electrolyte composition. As explained above in the context of the similar apparatus embodiment, one or more of the sub-sets may be formed by only a single first electrode. It is possible to implement the overall concept of establishing potentials at the major surfaces of at least the end electrode(s) that differ from those at the major surfaces of first electrodes in the array other than the end electrodes using only a plurality of electrical current sources. If this is done for each first electrode in the array, then, in the case of a symmetric arrangement with two second electrodes on either side of the array of first electrodes, each of the sub-sets may include two first electrodes, symmetrically arranged with respect to the middle of the array. Otherwise, there would generally be one first electrode in each sub-set. It is also possible to have larger sub-sets, in particular if the overall concept behind the method is also realised using pre-resistors. Each current source may comprise at least one voltage rectifier particular to that current source, i.e. not shared with the other current sources. It is also possible for current sources to share a voltage rectifier, but to have their own respective DC/DC-converter allowing for independent current supply to the sub-set of first electrodes connected to that current source. For apparatus to be used in a plant having a Direct Current microgrid, there need not be a voltage rectifier.

In an embodiment of the method, the step of causing electrical current to flow comprises feeding an electrical current between at least two of the first electrodes and a common electrical current source via pre-resistors arranged electrically between the major surfaces of the first electrodes electrically and the common electrical current source, wherein total resistance values of the pre-resistors through which current passes between the common electrical current source and the first electrode differ between first electrodes connected to the common electrical current source such as to decrease according to how many of the first electrodes are interposed in the array between the first electrode and a most proximal one of the at least one second electrodes.

This is another way of realising the concept of establishing potentials at the major surfaces of at least the end electrode(s) that differ from those at the major surfaces of the first electrodes in the array other than the end electrode by being closer to respective potentials of the second electrodes. In particular, this embodiment allows the potential to differ from one first electrode to the next throughout the array without using very many separate current sources. The method can be implemented with a common electrical current source configured or controlled only to supply or draw a particular total value of current to, respectively from, all the first electrodes connected to that common electrical current source. Equalisation between the individual first electrodes connected to the common current source is achieved by means of the pre-resistors. As mentioned, this embodiment can be combined with the embodiment using multiple separate current sources.

In an example of this embodiment, the first electrodes connected electrically in series with a common electrical current source are connected in a parallel circuit with respect to each other and the pre-resistors are arranged in respective branches of the parallel circuit in which the first electrodes are comprised, so that the total resistance values of the pre-resistor differ between the branches such as to decrease according to how many of the first electrodes are interposed in the array between the first electrode in the branch and a most proximal one of the at least one second electrodes.

Compared to an alternative in which the pre-resistors interconnect successive first electrodes in the array, this embodiment is relatively easy to implement with appropriate resistance values of the pre-resistors.

In any example of the embodiment in which the step of causing electrical current to flow comprises feeding an electrical current between at least two of the first electrodes and a common electrical current source via pre-resistors arranged electrically between the major surfaces of the first electrodes electrically and the common electrical current source, wherein total resistance values of the pre-resistors through which current passes between the common electrical current source and the first electrode differ between first electrodes connected to the common electrical current source such as to decrease according to how many of the first electrodes are interposed in the array between the first electrode and a most proximal one of the at least one second electrodes, the first electrodes are provided in the form of sheets, comprising at least a major section defining the major surfaces, and the sheet forming at least one of the first electrodes further comprises at least one section forming one of the pre-resistors and interconnecting the major section with at least one contact point electrically connecting the first electrode to a remainder of the circuit in which the first electrode is comprised.

Thus, the pre-resistors are in effect integrated into the first electrodes. This results in a compact arrangement that is relatively simple to manufacture.

The section forming one of the pre-resistors may, for example, be cut into the sheet in the form of a path from the contact point to the major section this path lying in the same plane when the sheet is arranged in planar form. The term sheet is also used in the context of this embodiment merely to indicate that the lateral dimensions of the two opposing major surfaces are much larger than a thickness corresponding to the dimension between the two opposing major surfaces. A sheet may be permeable to liquid, need not have a rectangular outline or be flexible to the extent that the sheet could, for example, be rolled up.

In an example of any embodiment of the method in which the step of causing electrical current to flow comprises feeding an electrical current between at least two of the first electrodes and a common electrical current source via pre-resistors arranged electrically between the major surfaces of the first electrodes and the common electrical current source, wherein total resistance values of the pre-resistors through which current passes between the common electrical current source and the first electrode differ between first electrodes connected to the common electrical current source such as to decrease according to how many of the first electrodes are interposed in the array between the first electrode and a most proximal one of the at least one second electrodes the electrical current is fed between the electrical current source and a pre-resistor formation in which current paths of different electrical resistance are formed that constitute respective ones of the pre-resistors.

This example can be implemented without substantial modification of existing first electrode designs, other than to provide connections to the second electrical contact points. The pre-resistor formation will generally be a shaped contiguous mass of one or more electrically conducting materials. Suitable materials include titanium, for example. The formation need not be self-supporting and may in principle have any shape. The formation may be formed by moulding, cutting, e.g. laser cutting, milling, welding, soldering or any combination, for example. Sections of the current paths may be shared between current paths.

In an example of this embodiment, electrical current is passed between the pre-resistor formation and at least two spaced-apart electrical contact points of each of the at least two of the first electrodes connected electrically in with the common electrical current source via pre-resistors.

This embodiment reduces voltage differentials across the major surfaces of that first electrode. There is thus a more uniform distribution of the current density of the electrical current passing between the electrolyte and those surfaces.

In an embodiment of the method, the array of first electrodes is at least partially enclosed by a housing, the second electrode(s) is or are arranged outside the housing, and the housing comprises at least one permselective membrane separating an interior of the housing from an exterior of the housing.

The housing may enclose the array of first electrodes up to a level of electrolyte present, in use, in the container outside the housing, for example. In this embodiment, reaction products obtained at the first electrodes cannot migrate and be converted back at one of the second electrodes. This embodiment also potentially allows for the use of different electrolytes, e.g. a catholyte and an anolyte, having different respective compositions. The permselective membrane will then be configured to form a barrier for at least one ion species present in one of the electrolytes but not in the other. It is thus possible to include e.g. a catalyst, such as silver, in only one of the electrolytes and to ensure that reaction products generated at the first electrodes are not converted back at the second electrode or electrodes or vice versa. It is also possible to pass only one of the electrolytes through the apparatus, e.g. where this electrolyte comprises a solution to be electrochemically re-generated such as an etching solution comprising manganese species to be electrochemically re-oxidised. The membrane may, for example, only be permeable to cations. A suitable membrane material includes, for example, nafion (a sulfonated tetrafluoroethylene-based fluoropolymer-copolymer).

In an example of this embodiment therefore, but for the at least one permselective membrane(s), the housing is arranged to provide a separation of liquid in the interior of the housing from the exterior of the housing. Thus, one of a first and second electrolyte can be passed through either the interior of the housing, but not the container interior outside the housing, or one of a first and second electrolyte can be passed through the container interior outside the housing, but not through the interior of the housing.

In another embodiment of the method, the array of first electrodes is at least partially enclosed by a housing arranged to provide a separation of liquid in an interior of the housing from an exterior of the housing, and the at least one second electrodes are attached to the housing such that at least one section of each of the second electrodes is exposed to the interior of the housing.

In this case, there can be only one electrolyte, e.g. a solution pumped through the apparatus to be re-generated by electrochemical oxidation. Because the effective surface area of the first electrodes is much larger than the exposed surface of the second electrodes, the reaction products obtained at the first electrodes do not all migrate to the second electrodes to be converted back, in particular if the electrolyte is passed through the interior of the housing. The container interior can have a relatively small volume available for accommodating the electrolyte. The remainder is occupied essentially by the first electrodes.

In an example of any embodiment of the method in which either: (i)
the array of first electrodes is at least partially enclosed by a housing, the second electrode(s) is or are arranged outside the housing, and the housing comprises at least one permselective membrane separating an interior of the housing from an exterior of the housing, and, but for the at least one permselective membrane(s), the housing is arranged to provide a separation of liquid in the interior of the housing from the exterior of the housing; or
(ii) the array of first electrodes is at least partially enclosed by a housing arranged to provide a separation of liquid in an interior of the housing from an exterior of the housing, and the at least one second electrodes are attached to the housing such that at least one section of each of the second electrodes is exposed to the interior of the housing, the method further comprises passing electrolyte through the interior of the housing.

This embodiment is suitable for use in re-generating solutions such as etching solutions, e.g. by electrochemically oxidising at least one constituent of the solution, or for plating out one or more constituents of a processing solution, for example. Passing electrolyte through the interior of the housing may, but need not, comprise circulating the electrolyte.

In an example of any embodiment in which the array of first electrodes is at least partially enclosed by a housing, the second electrode(s) is or are arranged outside the housing, and the housing comprises at least one permselective membrane separating an interior of the housing from an exterior of the housing, and, but for the at least one permselective membrane(s), the housing is arranged to provide a separation of liquid in the interior of the housing from the exterior of the housing, optionally in combination with passing electrolyte through the interior of the housing, providing the at least one electrolyte in the container comprises providing a first electrolyte in the interior of the housing and a second electrolyte in the container interior outside the housing, the first and second electrolyte differing in terms of their composition.

This allows for the use of, for example, a particular catalyst only in the electrolyte to which the first electrodes are exposed. An example would be silver ions. Also, if one of the electrolytes is passed through the apparatus for the purpose of removing or re-generating a constituent thereof, then the other electrolyte need not comprise that constituent, of course.

In an embodiment of the method, ions, e.g. ions comprising manganese species, in at least one of the at least one electrolytes are electrolytically oxidised, e.g. as a step in a process of at least partly regenerating an etching solution.

Such etching solutions are commonly used to prepare non-metallic surfaces in a plating process, e.g. one including an electroplating step. The etching solution may be relatively acidic, e.g. comprising phosphoric acid, which ordinarily causes negatively charged manganese ions to revert to manganese oxide. The method of this embodiment allows this process to be reversed.

According to an independent third aspect, the second object underlying the invention is achieved by the electrode unit according to the invention, which is characterised in that at least one of the electrodes is separated from a neighbouring electrode in the array by at least one spacer comprising a thread made of a different material from the electrically conductive material, threaded through the mesh of the electrode as a sequence of stitches.

There may be more than one thread. One or more threads may be arranged as a sequence of stitches forming a loop, seen looking onto one of the major surfaces. With the stitches, it is possible to provide spacers with a low area of contact with the electrodes at relatively many locations. This is achieved relatively efficiently, in that forming the stitches fixes the spacer in place. There is no need for further fasteners and no need to handle a large number of separate spacer elements. In the present context, a mesh may be woven, knitted, welded, sintered, etched or electroformed, for example. The strands of material making up the mesh may be, but need not be separate or intertwined, therefore. They may simply be the result of forming a very large number of apertures in a sheet forming a precursor of the electrode. A sheet in the present context is a formation having lateral dimensions seen perpendicular to one of two opposing major surfaces of the sheet that are much larger than a thickness between the two major surfaces. It is noted that, since the sheets comprise a mesh, the effective surface area will be much larger than that defined by the lateral dimensions.

The electrode unit may be for use in an apparatus according to the first aspect of the invention and/or a method according to the second aspect of the invention.

The sheets may, for example, have a surface factor of 1 or higher, e.g. 1.4 or more, 1.7 or more, or even 2, 2.2 or more, where surface factor denotes a parameter corresponding to the total effective surface area per geometric area.

The thickness of each sheet may be in the order of micrometres, e.g. in the range of 1-2 μm. The distance between the sheets may in the order of mm.

The thread may be a monofilament or comprise multiple filaments spun into a thread. The thread may have a diameter in the order of mm, e.g. in the range of 0.5-5 mm, more particularly in the range of 0.5-2 mm.

In an embodiment of the electrode unit, the material of the thread has a lower electrical conductivity than the electrically conductive material.

The thread is thus made of electrically insulating material. A suitable material would be polyvinylidene difluoride. A thread made of electrically insulating material is particularly suited for use in an apparatus according to the first aspect, because it allows not only the electrolyte to contact a relatively high electrode surface area but also electrically isolates the facing major surfaces of neighbouring electrodes from each other. They can therefore be maintained at different electrical potentials.

In an example of the embodiment in the material of the thread has a lower electrical conductivity than the electrically conductive material, the electrode unit comprises a plurality of electrical current feeders for electrical connection to separate electrical current sources external to the electrode unit, wherein the plurality of electrical current feeders are electrically connected to disjoint sub-sets of the electrodes in the array, each sub-set comprising at least one of the electrodes.

This embodiment is also particularly suited for use in an apparatus according to the first aspect, because the embodiment allows separate current sources to pass current through the electrodes and the electrolyte. It is thus possible to configure or actively control these current sources such that the current passing through the electrodes made more uniform over all electrodes in the array. This allows the apparatus in which the electrode unit is comprised to be operated at close to the maximum current density at which yields start to diminish strongly and the risk of excessive loss of certain surface coatings such as platinum starts to increase strongly.

In an example of any embodiment of the electrode unit in which the material of the thread has a lower electrical conductivity than the electrically conductive material, at least two of the electrodes are connected electrically in series with a common one of the at least one electrical current feeders, pre-resistors are arranged electrically between major surfaces of the electrodes electrically connected to the common current feeder, and total resistance values of the pre-resistors between the common current feeder and the electrode differ between the electrodes connected to the common current feeder such as to decrease according to how many electrodes removed from a proximal one of end electrodes terminating the array at either end the electrode is.

This embodiment is also particularly suited for use in an apparatus according to the first aspect, because the embodiment allows to equalise the currents through the electrodes even where they are connected to a common current source.

In an example of this embodiment, the electrodes connected electrically in series with a common one of the at least one electrical current feeders are connected in a parallel circuit with respect to each other and the pre-resistors are arranged in respective branches of the parallel circuit in which the electrodes are comprised, so that the total resistance values of the pre-resistors differ between the branches such as to decrease according to how many electrodes removed from a proximal one of end electrodes terminating the array at either end the electrode in the branch is

This embodiment is relatively easy to implement with appropriate resistance values for the pre-resistors. In the alternative, pre-resistors interconnect successive electrodes connected to a common current feeder. The resistance of the path through a first electrode from one pre-resistor to the next would need to be taken into account.

In any example of the embodiment in which the material of the thread has a lower electrical conductivity than the electrically conductive material, at least two of the electrodes are connected electrically in series with a common one of the at least one electrical current feeders, pre-resistors are arranged electrically between major surfaces of the electrodes electrically connected to the common current feeder, and total resistance values of the pre-resistors between the common current feeder and the electrode differ between the electrodes connected to the common current feeder such as to decrease according to how many electrodes removed from a proximal one of end electrodes terminating the array at either end the electrode is, the sheets of the electrodes comprise at least a major section and at least one section forming one of the pre-resistors and interconnecting the major section and at least one of the at least one electrical contact points.

Thus, the pre-resistors are integrated into the electrodes. This allows to keep the electrode unit relatively compact. Furthermore, it is relatively easy to provide pre-resistors with different resistance values. Assembly of the electrode unit is not appreciably complicated. The sections forming the pre-resistors can be provided by cutting differently shaped current paths in the meshes. The meshes can otherwise have the same configuration.

In an example of any embodiment in which the material of the thread has a lower electrical conductivity than the electrically conductive material, at least two of the electrodes are connected electrically in series with a common one of the at least one electrical current feeders, pre-resistors are arranged electrically between major surfaces of the electrodes electrically connected to the common current feeder, and total resistance values of the pre-resistors between the common current feeder and the electrode differ between the electrodes connected to the common current feeder such as to decrease according to how many electrodes removed from a proximal one of end electrodes terminating the array at either end the electrode is, the electrode unit further comprises at least one pre-resistor formation, wherein the pre-resistor formation is provided with at least one first electrical contact point electrically connected to one of the at least one electrical current feeders and with a plurality of second electrical contact points, wherein at least two of the second electrical contact points are electrically connected to contact points of different respective electrodes via a respective one of the plurality of electrical conductors, and wherein current paths of different electrical resistance are formed in the pre-resistor formation between at least one of the at least one first contact points and second contact points electrically connected to contact points of different respective electrodes.

This example can be implemented without substantial modification of existing electrode designs, other than to provide connections to the second electrical contact points. The pre-resistor formation will generally be a shaped contiguous mass of one or more electrically conducting materials. Suitable materials include titanium and niobium, for example. The formation need not be self-supporting and may in principle have any shape. The formation may be formed by moulding, cutting, e.g. laser cutting, milling, welding, soldering or any combination, for example. Sections of the current paths may be shared between current paths.

In a particular example of this embodiment, the pre-resistor formation comprises a sheet with mutually separated current paths formed therein, wherein the current paths of different electrical resistance differ in terms of at least one of length and cross-sectional area perpendicular to a direction of progression of the current path along the length of the current path.

This embodiment is relatively easy to manufacture. The sheet may be self-supporting or provided in the form of a foil on a support plate. The paths may be obtained by cutting out their outlines in the sheet, e.g. by means of laser cutting. It follows that the term sheet does not in this context imply a particular outline. Although a pre-cursor of the pre-resistor formation may be a rectangular sheet or more generally have an outline prior to the forming of the current paths that is a convex curve, the process of forming the current paths will generally result in edges deviating from straight lines. The maximum lateral dimensions will still be much larger than the thickness of the pre-resistor formation, however.

In an example of any embodiment in which the material of the thread has a lower electrical conductivity than the electrically conductive material, at least two of the electrodes are connected electrically in series with a common one of the at least one electrical current feeders, pre-resistors are arranged electrically between major surfaces of the electrodes electrically connected to the common current feeder, total resistance values of the pre-resistors between the common current feeder and the electrode differ between the electrodes connected to the common current feeder such as to decrease according to how many electrodes removed from a proximal one of end electrodes terminating the array at either end the electrode is, the electrode unit further comprises at least one pre-resistor formation, the pre-resistor formation is provided with at least one first electrical contact point electrically connected to one of the at least one electrical current feeders and with a plurality of second electrical contact points, at least two of the second electrical contact points are electrically connected to contact points of different respective electrodes via a respective one of the plurality of electrical conductors, and current paths of different electrical resistance are formed in the pre-resistor formation between at least one of the at least one first contact points and second contact points electrically connected to contact points of different respective electrodes, the pre-resistor formation is interposed between two of the electrodes in the array.

The electrode unit is thus relatively compact. the array is in effect a modified electrode stack.

In an example of any embodiment in which the material of the thread has a lower electrical conductivity than the electrically conductive material, at least two of the electrodes are connected electrically in series with a common one of the at least one electrical current feeders, pre-resistors are arranged electrically between major surfaces of the electrodes electrically connected to the common current feeder, total resistance values of the pre-resistors between the common current feeder and the electrode differ between the electrodes connected to the common current feeder such as to decrease according to how many electrodes removed from a proximal one of end electrodes terminating the array at either end the electrode is, the electrode unit further comprises at least one pre-resistor formation, the pre-resistor formation is provided with at least one first electrical contact point electrically connected to one of the at least one electrical current feeders and with a plurality of second electrical contact points, at least two of the second electrical contact points are electrically connected to contact points of different respective electrodes via a respective one of the plurality of electrical conductors, and current paths of different electrical resistance are formed in the pre-resistor formation between at least one of the at least one first contact points and second contact points electrically connected to contact points of different respective electrodes, the pre-resistor formation is at least partly covered by a housing made of material having a lower electrical conductivity than material of the pre-resistor formation.

The housing is electrically insulating, so that there are no leakage currents from the pre-resistor formation to, for example, electrodes of opposite polarity to that of the electrodes in the electrode unit. The pre-resistor formation can thus be partly or completely immersed in the electrolyte, in use. The housing may, but need not, sealingly enclose the pre-resistor formation. There may, but need not, be a gap between the housing and the pre-resistor formation, so that covering does not necessarily mean that surfaces of the two touch each other.

In an embodiment of the electrode unit, at least one of the plurality of electrical conductors connecting a contact point of one of the electrodes passes through at least one other of the electrodes, e.g. in a bushing passing through the at least one other electrodes, which bushing is made of material having a lower electrical conductivity than the electrically conductive material.

In an embodiment of the electrode unit, at least one of the electrodes comprises at least two of the electrical contact points, which are spaced apart from each other.

This embodiment allows to provide the electrode with a more uniform surface potential. Locally excessive current density values can be avoided without reducing the overall current passing through the electrode, in use, too much.

In an embodiment of the electrode unit, the electrodes comprise at at least their surfaces, e.g. only in surface coatings, at least one of lead, tantalum, a platinum group metal or an alloy or oxide thereof, e.g. at least one of platinum, a platinum alloy or platinum oxide.

The platinum group metal is effective in charge transfer to, in particular, catalysts such as silver ions in the electrolyte, or to the reagents directly. By providing a platinum group metal only at the electrode surface, e.g. only in a surface coating, the costs of the electrode unit are reduced. If provided as a surface coating, such a coating may have a thickness in a range of between 0.5 and 2 μm, for example. The thickness will be greater for other materials, e.g. in the range of 0.5-50 mm or 0.5-30 mm. Because the electrode unit is well-suited for use in an apparatus according to the first aspect, in which high current densities are avoided quite effectively, the electrodes do not wear out too quickly even if, for example, a platinum group metal is provided only at the electrode surface.

In an embodiment of the electrode unit, the meshes are made mainly of inert material, e.g. material comprising at least one of titanium, niobium and carbon.

The electrode unit can be immersed in relatively aggressive electrolytes. The material of the electrode unit does not participate in the electrochemical reactions, increasing the electrode lifetime and the yield.

In an embodiment of the electrode unit, at least one of the meshes is an expanded metal mesh.

Expanded metal is a type of sheet metal that has been cut and stretched to form a regular pattern of apertures. The apertures may be rhombus- or rhomboid-shaped, or example. These types of mesh are stronger than those formed from intertwined separate strands.

An embodiment of the electrode unit further comprises a housing at least partially enclosing the array of electrodes.

The housing protects the electrodes in the electrode unit and may also play a role in separating different electrolytes (e.g. a catholyte and an anolyte) from each other. Furthermore, the housing reduces the volume to be filled with electrolyte of which a component reacts at the electrodes, in use.

In an example of any embodiment that further comprises a housing at least partially enclosing the array of electrodes, the housing comprises at least one permselective membrane separating an interior of the housing from an exterior of the housing.

The housing may enclose the array of electrodes up to a level of electrolyte in which the electrode unit is at least partly immersed in the apparatus in which the electrode unit is deployed, for example. In this embodiment, reaction products obtained at the electrodes of the electrode unit cannot migrate and be converted back at electrodes of opposite polarity located outside the housing, and vice versa. This embodiment also potentially allows for the use of different electrolytes, e.g. a catholyte and an anolyte, having different respective compositions. The permselective membrane will then be configured to form a barrier for at least one ion species present in one of the electrolytes but not in the other. It is thus possible to include e.g. a catalyst, such as silver ions, in only one of the electrolytes. It is also possible to circulate only one of the electrolytes, e.g. where this electrolyte comprises a solution to be electrochemically re-generated such as an etching solution comprising manganese species to be electrochemically re-oxidised. The membrane may, for example, only be permeable to cations. A suitable membrane material includes, for example, nafion (a sulfonated tetrafluoroethylene-based fluoropolymer-copolymer), but a different choice of membrane material is possible.

In an example of this embodiment, therefore, but for the at least one permselective membrane, the housing is impermeable to liquid.

In another example of any embodiment of the electrode unit in which the electrode unit further comprises a housing at least partially enclosing the array of electrodes, the housing is impermeable to liquid, and the electrode unit further comprises at least one further electrode, attached to the housing such that at least one section of the further electrode is exposed to an interior of the housing.

This results in a relatively compact electrolytic cell that can be operated with a relatively low volume of electrolyte. The exposed sections of the further electrode or electrodes have a much smaller surface area than the total effective surface are of all the electrodes in the electrode unit, if only because there are fewer further electrodes. It is possible, however, for only selected sections of the further electrode to be exposed and a remainder to be shielded by either the housing or a separate shielding.

In an example of any embodiment further comprising a housing at least partially enclosing the array of electrodes, wherein either (i) the housing comprises at least one permselective membrane separating an interior of the housing from an exterior of the housing, and, but for the at least one permselective membrane, the housing is impermeable to liquid; or (ii) the housing is impermeable to liquid, and the electrode unit further comprises at least one further electrode, attached to the housing such that at least one section of the further electrode is exposed to an interior of the housing, the electrode unit further comprises at least one liquid inlet and at least one liquid outlet for connecting an interior of the housing to an inlet conduit and an outlet conduit, respectively, to enable an electrolyte to be passed through the interior of the housing.

This embodiment is suitable for use in re-generating solutions such as etching solutions, e.g. by electrochemically oxidising at least one constituent of the solution, or for plating out one or more constituents of a processing solution, for example. An alternative would be electrochemical oxidation of organic compounds, e.g. to purify aqueous liquids.

According to a fourth aspect, the second object underlying the invention is achieved by the apparatus for conducting an electrolytic process, e.g. an apparatus according to the first aspect of the invention, comprising:
a container for accommodating at least one electrolyte; an electrode unit according to the invention, arranged in the container;
at least one second electrode, arranged in the container; and
a current supply system electrically connected to the at least one electrical current feeders of the electrode unit and to the second electrodes for causing electrical current to flow via the second electrode(s) and major surfaces of the electrodes in the electrode unit through the at least one electrolyte.

In an embodiment of the apparatus, the electrode unit further comprises a housing at least partially enclosing the array of electrodes, wherein either (i)
the housing comprises at least one permselective membrane separating an interior of the housing from an exterior of the housing, and, but for the at least one permselective membrane, the housing is impermeable to liquid; or
(ii) the housing is impermeable to liquid, and the electrode unit further comprises at least one further electrode, attached to the housing such that at least one section of the further electrode is exposed to an interior of the housing. The electrode unit further comprises at least one liquid inlet and at least one liquid outlet for connecting an interior of the housing to an inlet conduit and an outlet conduit, respectively, to enable an electrolyte to be passed through the interior of the housing. The apparatus further comprises a liquid-conducting circuit comprising a pump for passing electrolyte through the interior of the housing of the electrode unit.

The circuit may comprise a reservoir. The circuit need not be closed. The inlet and outlet conduit may extend through a further part of an interior of the container, e.g. a further part for accommodating at least one of the at least one electrolytes, and through a wall of the container.

In an alternative, the housing can be arranged to function as a reservoir holding a stagnant quantity of electrolyte to be processed batchwise.

### BRIEF DESCRIPTION OF DRAWINGS

The invention will be explained in further detail with reference to the accompanying drawings, in which:

FIG. 1 is a schematic diagram of a first apparatus for conducting an electrolytic process, not to scale or with all parts in the correct orientation;

FIG. 2 is a perspective view of a cell for an apparatus of the type shown schematically in FIG. 1, with cathodes removed;

FIG. 3 is a detailed perspective view of the cell with the majority of a housing of the cell and ducts connected to the housing removed;

FIG. 4 is a first perspective view of an assembly of a support plate and pre-resistor plate comprised in the cell of FIGS. 2 and 3;

FIG. 5 is a perspective view of an opposite side of the support plate of FIG. 4;

FIG. 6 is a plan view of the pre-resistor plate on the support plate;

FIG. 7 is a perspective view of two innermost electrodes in an electrode array comprised in the cell of FIGS. 2-6;

FIG. 8 is a plan view of a mesh comprised in an electrode in the cell of FIGS. 2-7;

FIG. 9 is a detailed view of the mesh that also shows a spacer with which the mesh is provided;

FIG. 10 is a plan view of a contact point and integral pre-resistor comprised in an electrode usable in the cell of FIGS. 2-9;

FIG. 11 is a diagram showing part of a resistance network usable in a process of designing the pre-resistors of the cell of FIGS. 2-9;

FIG. 12 is a schematic diagram of a second apparatus for conducting an electrolytic process, not to scale or with all parts in the correct orientation;

FIG. 13 is a perspective view of a cell for an apparatus of the type shown schematically in FIG. 12;

FIG. 14 is a perspective view of the cell of FIG. 13 without cathodes or electrical conductor bars connecting to the cathodes;

FIG. 15 is a perspective view of the electrode unit;

FIG. 16 is a detailed perspective view of the electrode unit;

FIG. 17 is a view corresponding to that of FIG. 16, but with the electrodes removed except for end electrodes;

FIG. 18 is a plan view of a first alternative spacer configuration; and

FIG. 19 is a plan view of a second alternative spacer configuration.

### DESCRIPTION OF EMBODIMENTS

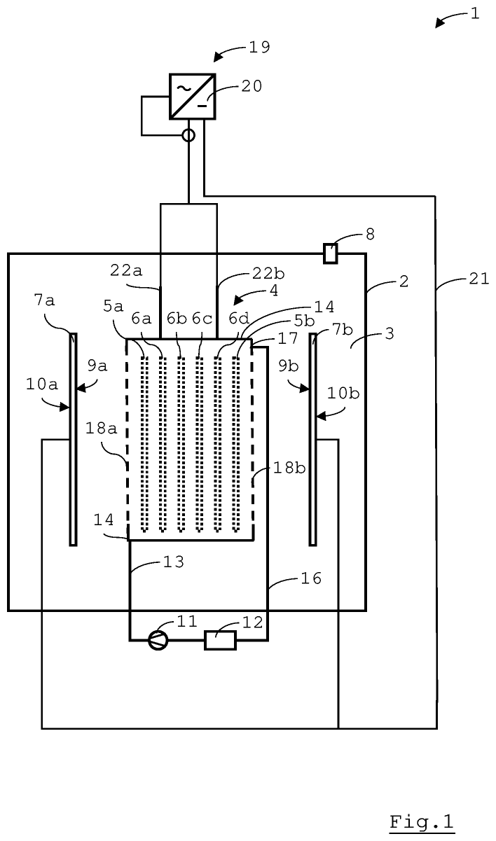

A first apparatus 1 (FIG. 1) for conducting an electrolytic process comprises a container 2 having a container interior 3. Disposed in the container interior 3 are an electrode unit 4 comprising an array of spaced-apart first electrodes, including two end electrodes 5a,b and, in this simplified example, four further first electrodes 6a-d. Also disposed in the container interior 3 are two second electrodes 7a,b. The second electrodes 7a,b are arranged to have an opposite polarity to that of the first electrodes 5a,b,6a-d, in use. In the example to be discussed, the second electrodes 7a,b function as cathodes. The first electrodes 5a,b,6a-d in the electrode unit 4 function as anodes.

The container 2 is provided with a fill opening 8 for filling the majority of a space in the container interior 3 surrounding the electrode unit 4 with a first electrolyte, also referred to herein as a catholyte.

In the filled state of the container interior 3, the second electrodes 7a,b are completely immersed in the catholyte, since the second electrodes 7a,b are completely exposed to the part of the container interior 3 surrounding the electrode unit 4.

The second electrodes 7 are planar, having a first major surface 9a,b with a normal directed towards the electrode unit 4 and a second major surface 10a,b having a normal extending in the opposite direction. The first electrodes 5a,b,6a-d are also planar, with the planes oriented generally in parallel to those of the second electrodes 7a,b.

The first electrodes 5a,b,6a-d are interposed between the second electrodes 7a,b. The end electrodes 5a,b have one major surface directed towards a proximal one of the second electrodes 7a,b. Each of the end electrodes 5a,b is interposed between a proximal one of the two second electrodes 7a,b and all of the further first electrodes 6a-d and the other end electrode 5a,b. The further first electrodes 6a-d each have at least one of the end electrodes 5a,b interposed between them and the second electrodes 7a,b.

The first electrodes 5a,b,6a-d each comprise a sheet in the form of a mesh, made of inert material, e.g. titanium, niobium, alloys thereof or carbon. In a particular embodiment, the mesh is an expanded metal mesh. The mesh may be coated, e.g. with a layer of platinum.

The second electrodes 7a,b may be provided in the form of sheets, each comprising a mesh. In alternative embodiments, they may be provided in the form of solid plates. The second electrodes 7a,b may be made of inert material, e.g. titanium, niobium, alloys thereof or carbon. The second electrodes 7a,b may alternatively be made of stainless steel.

A liquid-conducting circuit comprises a pump 11 and a reservoir 12, as well as an inlet conduit 13 connecting the pump 11 to a liquid inlet 14 of a housing 15 of the electrode unit 4 and an outlet conduit 16 leading from a liquid outlet 17 of the housing 15 back to the reservoir 12. Thus, a second electrolyte, also referred to herein as an anolyte, can be passed through the housing 15 of the electrode unit 4.

The first and second electrolyte may differ in terms of their composition, including the nature and/or relative proportions of their constituents. In an example, the first and second electrolytes both comprise phosphoric acid, but the second electrolyte additionally comprises one or more further components, e.g. silver ions, which act as a catalyst. The second electrolyte also comprises manganese species, including manganese oxide to be converted into manganese species having a higher oxidation number, e.g. permanganate ions, as part of a process of regenerating an etching solution. The regenerated solution is collected in the reservoir 12, from which this solution can be removed, in use.

The housing 15 of the electrode unit 4 comprises at least a section comprising one or more permselective membranes 18a,b allowing liquid to pass through, but forming a barrier to cations, or at least certain cation species. The permselective membranes 18a,b may in particular form a barrier to manganese species, such as manganese oxide and permanganate ions.

A current supply system comprises a current source 19, in the example a controllable current source. The current source 19 is arranged to be connected to the electrical grid (not shown), and therefore comprises a rectifier 20. The current supply system is arranged to cause electrical current to flow between the first electrodes 5a,b,6a-d of the electrode unit 4 on the one hand and the second electrodes 7a,b on the other, through the first and second electrolytes and an electrical circuit section 21 external to the container 2.

Because the current source 19 is controllable, the total current can be controlled to have a particular value. The first electrodes 5a,b,6a-d are connected electrically in a parallel circuit with respect to each other, but in series with the current source 19 via current feeders 22a,b extending from the electrode unit 4 into the part of the container interior 3 surrounding the electrode unit 4. The individual currents through the first electrodes 5a,b,6a-d of the electrode unit 4 are not controlled separately, but their relative values are determined by pre-resistors (not shown in FIG. 1) arranged in respective branches (not necessarily all of them) of the parallel circuit in which the first electrodes 5a,b,6a-d are comprised. Resistance values of the pre-resistor differ between the branches such as to decrease according to how many of the first electrodes are interposed between the first electrode in the branch and the most proximal one of the second electrodes 7a,b. Thus, the pre-resistor value will be highest for the end electrodes 5a,b and decrease towards the middle of the array. There may be no pre-resistors for further first electrodes 6b,c in the centre of the array.

Although this is not shown in FIG. 1, the second electrodes 7a,b may be mounted to the housing 15 of the electrode unit 4 to form a cell for immersion in the container interior 3. The container interior 3 may thus have a relatively low volume. This is of particular use when the apparatus 1 is used to convert manganese species into manganese species having a higher oxidation number, because the latter have a tendency to revert back to species with a lower oxidation number relatively quickly.

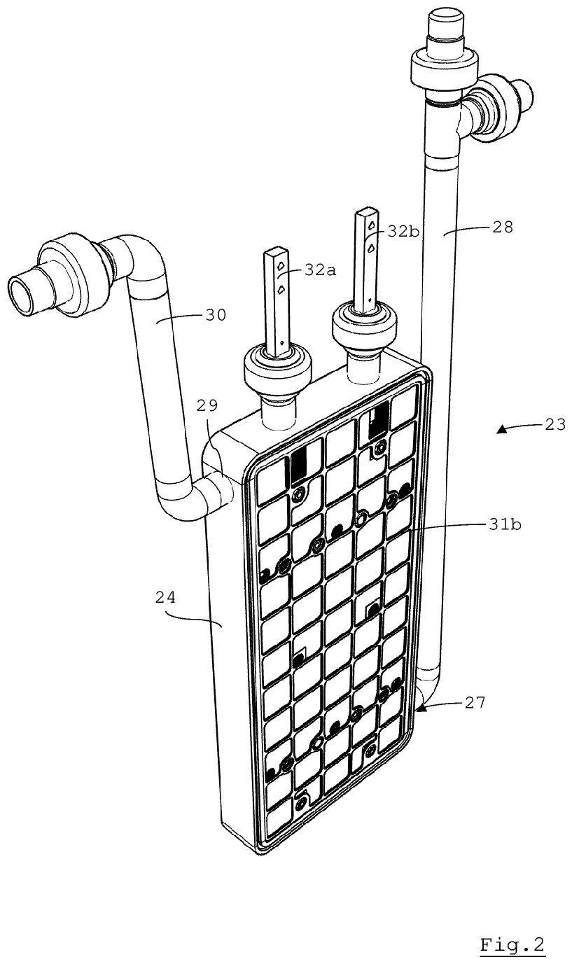

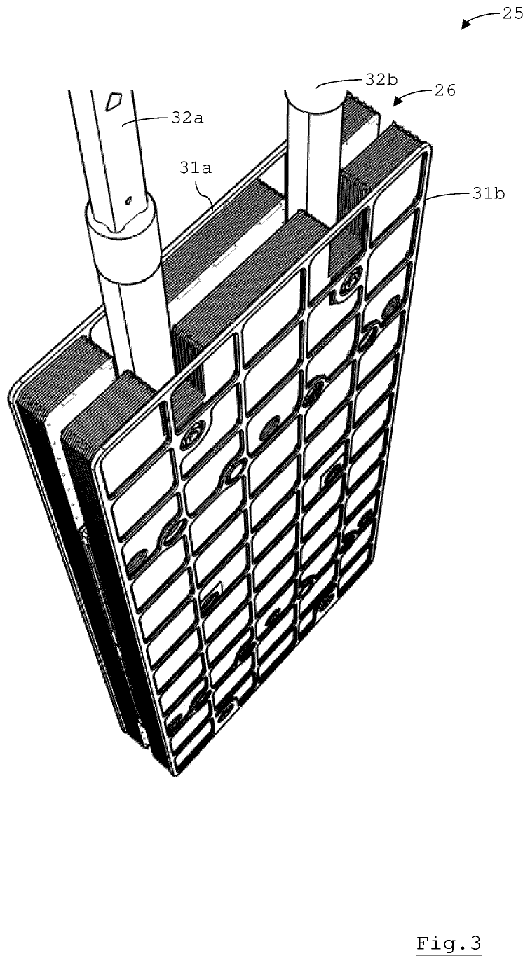

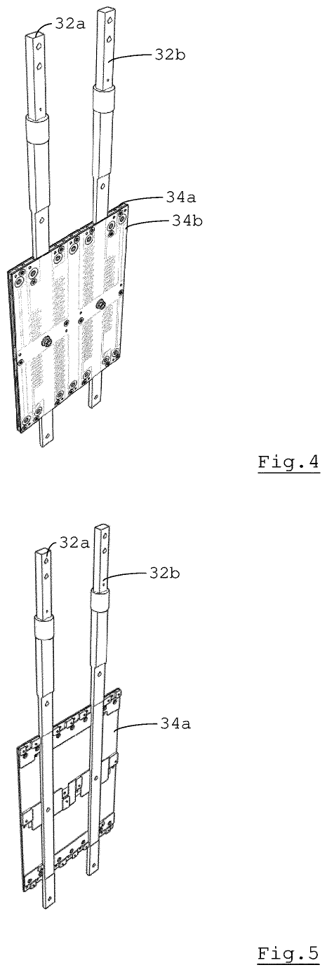

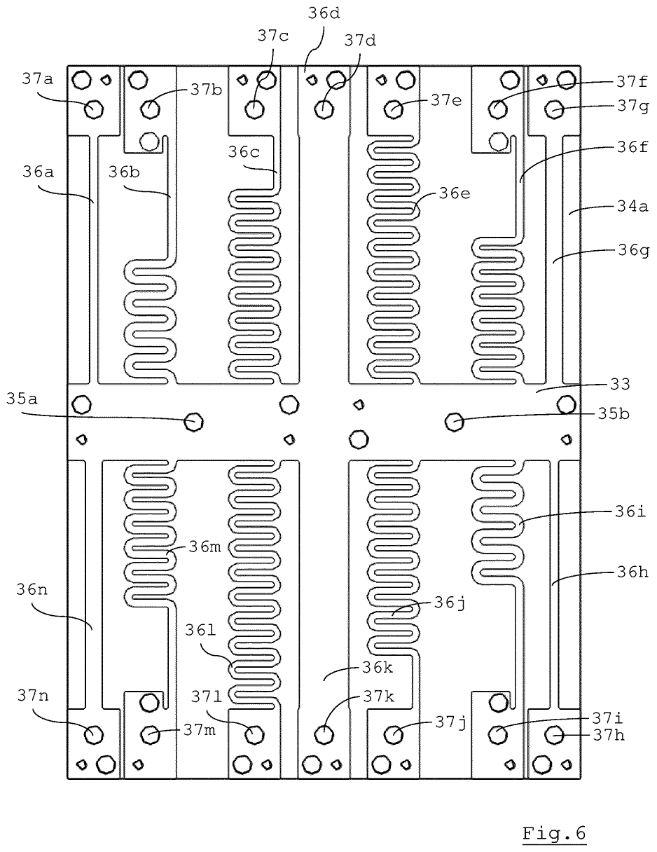

An example of such a cell 23 (FIGS. 2-10), shown here with the second electrodes removed however, comprises a housing 24 (FIG. 2). The housing 24 at least partially, in this example only partially, encloses an electrode unit 25 (FIG. 3). The electrode unit 25 comprises a first electrode array 26, comprised of first electrodes which are electrically isolated from each other. The description of the electrode unit 4 given above with reference to FIG. 1 applies also to the electrode unit 25 of the cell 23 and to the first electrode array 26.

Thus, the housing 24 is provided with a liquid inlet 27 for connecting an interior of the housing 24 to an inlet conduit 28. The housing 24 is also provided with a liquid outlet 29 for connecting the interior of the housing 24 to an outlet conduit 30. This enables an electrolyte, e.g. an anolyte, to be passed through the interior of the housing 24 in the manner described above in relation to the first apparatus 1.

The housing 24 is impermeable to liquid, but open at opposite ends, where distance plates 31a,b provided with liquid-permeable windows (FIG. 2) are arranged. In one embodiment, a respective permselective membrane is arranged in each window. In another embodiment, a permselective membrane is sealingly mounted against the distance plate 31a,b so as to cover the liquid-permeable windows.

In the illustrated embodiment, the distance plates 31a,b are comprised in the electrode unit 25, being mounted to the first electrode array 26 in close proximity to end electrodes at opposite ends of the first electrode array 26. A circumferential seal is provided between each distance plate 31a,b and the housing 24 to provide a separation of liquid between an interior of the housing 24 and an exterior, i.e. the space around the housing 24.

As illustrated and similarly to the first apparatus 1, two current feeders 32a,b extend through the housing 24. Seals ensure the separation of liquid between an interior of the housing 24 and an exterior is also maintained at this location. The current feeders 32a,b can be made of copper, for example, or another type of electrically conducting material. The current feeders 32a,b may be arranged in liquid-impermeable ducts to isolate them from electrolyte in which the cell 23 is immersed, in use. The current feeders 32a,b are configured for electrically connecting the first electrode array 26, in this case each of the first electrodes comprised therein, to a current supply external to the electrode unit 25.

As in the first apparatus 1, the cell 23 is configured such that, when connected to the current supply, the resulting apparatus is configured to establish potentials at major surfaces of the first electrodes in the first electrode array 26 that differ from one first electrode to the next, such that a potential differential to a potential of a most proximal one of the second electrodes of the cell 23 increases according to how many of the first electrodes are interposed between the first electrode and the most proximal second electrode. This is again achieved by means of pre-resistors having a resistance value that increases from one first electrode to the next towards the end electrodes, starting at the centre of the first electrode array if there are two second electrodes or at the most distal first electrode if there is only one second electrode.

In the illustrated embodiment, the pre-resistors are integrated into a pre-resistor formation 33 cut from a foil and applied to a support plate 34a,b (FIGS. 4-6). There are two such assemblies in the illustrated embodiment.

They are arranged symmetrically and each connected to both current feeders 32a,b at first electrical contact points 35a,b. The support plates 34a,b are made of electrically insulating material, having a lower electrical conductivity than the material of the pre-resistor formation. In the illustrated embodiment, a further foil of material having a lower electrical conductivity than the pre-resistor formation 33 is applied to the other side of the pre-resistor formation 33 to form a housing made of material having a lower electrical conductivity. The materials of the further foil and the support plates 34a,b need not be the same.

Current paths 36a-n are formed in the pre-resistor formation. The current paths 36a-n are formed between the first electrical contact points 35a,b and respective second electrical contact points 37a-n. Each second electrical contact point 37 is connected to one of the first electrodes in the first electrode array 26. The electrical resistances of the current paths 36 differ according to which first electrode the second electrical contact point 37 is connected to.

In the illustrated embodiment, the current paths 36a-n differ in terms of length and cross-sectional area. Here, the cross-sectional area is the area of a cross-section perpendicular to a direction of progression along the length of the path, i.e. along a neutral axis of the path. Being cut from foil, the current paths 36a-n are of the same height. Certain current paths 36b,c,e,f,i,j,l,m comprise at least a meandering section, meaning the direction of progression along the length of the path changes relatively often. Certain current paths 36a,d,g,h,k,n are straight. The length, contour and cross-section of the current paths 36a-n determine their resistances.

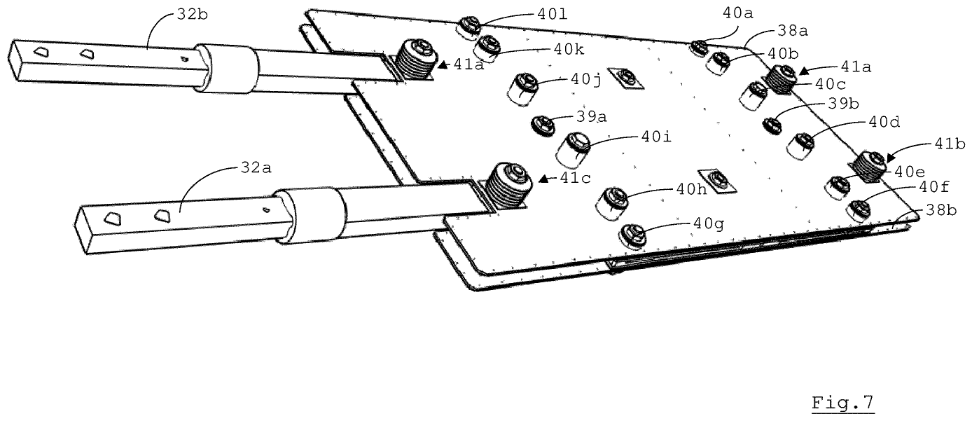

It will be apparent that the current feeders 32a,b, and assemblies of support plate 34 and pre-resistor formation 33 are interposed between central first electrodes 38a,b (FIG. 7) at the centre of the first electrode array 26.

The second electrical contact points 37a-n are electrically connected to pairs of first electrodes, one on either side of the pre-resistor formations 33a,b, by means of electrical conductors in the form of bolts or in the form of rods provided with threads at both ends. In the case of the central first electrodes 38a,b, the electrical conductors pass only through these central first electrodes 38a,b. Nuts and discs clamp the electrical conductors to the central first electrodes 38a,b. In the illustrated embodiment, there are two conductors and they are clamped to each central first electrode 38 at contact points 39a,b spaced apart in the plane of the central first electrode 38a,b.

The electrical conductors interconnecting the second electrical contact points 37a-c,e-j,l-n to other first electrodes are of different lengths and pass through the first electrodes interposed between the pre-resistor formations 33a,b and the first electrode to which they connect. To avoid short-circuits, such electrical conductors are arranged in bushings 40a-l made of electrically insulating material. Again, nuts and discs are provided at the ends of the electrical conductors to hold the first electrode at spaced-apart electrical contact points.

In addition, there are further bolts or rods with threaded ends along the length of which arrays of discs 41a-d are provided. The discs of these arrays 41a-d are made of electrically insulating material. These assemblies serve only to hold the first electrodes, with the discs of the arrays 41a-d serving as spacers interposed between neighbouring first electrodes in the first electrode array 26.

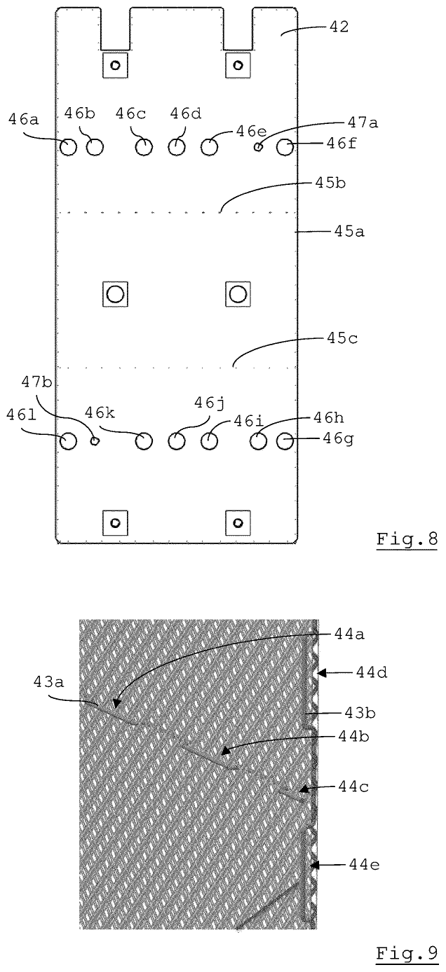

With reference to an exemplary first electrode 42 (FIGS. 8,9), at least one thread 43a,b of electrically insulating material is threaded through the mesh forming the electrode in the form of a sequence of stitches 44a-e. In the illustrated embodiment, a sequence path 45a at a circumference of the exemplary first electrode 42 extends along this circumference. Further sequence paths 45b,c extend across a plane defined by the exemplary first electrode 42.

The threads 43a,b may be monofilaments or multi-filament threads. A suitable material is polyvinylidene difluoride.

One can see that the exemplary first electrode 42 is provided with a number of apertures 46a-l through which the bushings 40 can pass, as well as with two spaced-apart electrical contact points 47a,b.

In addition to providing pre-resistors as integral parts of the pre-resistor formations 33a,b, it is alternatively or additionally possible to integrate pre-resistors into one or more of the electrodes in the first electrode array 26. In that case, the sheet forming one of the first electrodes comprises at least a major section 48, of which only a part is shown (FIG. 10), and a pre-resistor section 49 forming one of the pre-resistors and interconnecting the major section 48 with at least one of the electrode contact points 50 electrically connecting the first electrode to a remainder of the branch of the parallel circuit in which that first electrode is comprised. In the illustrated embodiment (FIG. 10), the first electrode is made of expanded metal. The pre-resistor section 49 comprises a meandering path of which the outline has been cut, e.g. laser-cut, into the mesh of expanded metal. The basic shape of this path is a spiral around the electrode contact point 50, with an undulating shaped super-imposed due to the basis lattice shape of the mesh out of which the path has been cut. The electrical resistance can easily be set during manufacturing by choosing an appropriate length for the spiral.

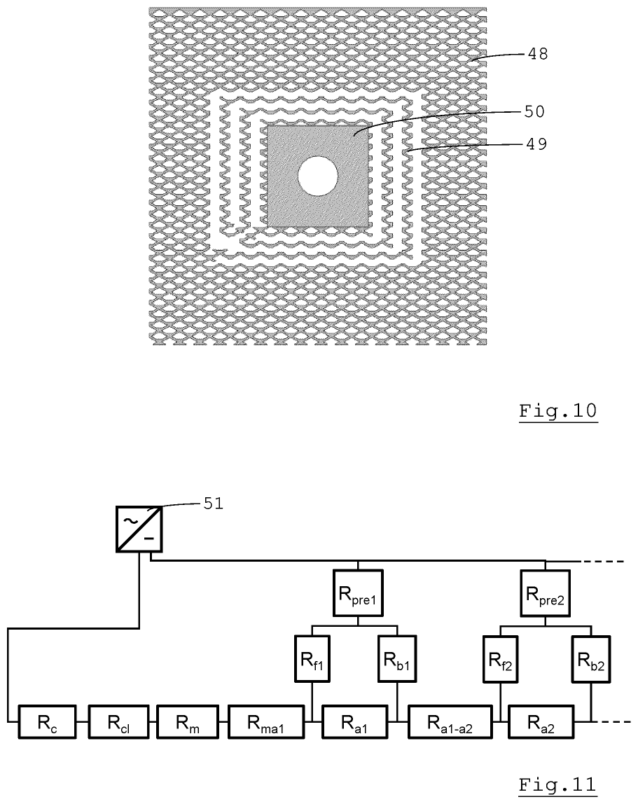

A method of selecting appropriate pre-resistor values comprises modelling the first apparatus 1. The model includes a model current source 51 (FIG. 11). The model further includes a cathode resistance R_{c} representative of the electrical resistance of the second electrode, in this case a cathode. The resistance R_{c} representative of the electrical resistance of the second electrode is taken to be a fixed value, amongst others because the electrolyte in which the second electrode is immersed in use functions as a coolant. A catholyte resistance R_{cl} is representative of the electrical resistance of a current path through the electrolyte in which the second electrode is immersed to a membrane separating that electrolyte from the electrolyte in which first electrodes of the array of first electrodes are immersed. The value of the catholyte resistance R_{cl} is variable, but can be taken from a current-potential curve for the electrolyte. The model further includes a membrane resistance Rₘ, representative of the electrical resistance encountered by the electrical current passing through the membrane between the electrolyte in which the second electrode is immersed and the electrolyte in which the first electrodes are immersed. The value of the membrane resistance Rₘ can be taken to be fixed. This value can be calculated from the membrane dimensions and a conductivity value. The model further includes a first anolyte resistance Rₘₐ₁, representative of the electrical resistance of a current path through the electrolyte in which the first electrodes are immersed from the membrane to one of the end electrodes. The value of the first anolyte resistance Rₘₐ₁ is fixed. This value can be calculated from the electrolyte resistivity, path length and cross-sectional areas of the end electrode and membrane. There is then a first first electrode electrolyte resistance Rₐ₁, which is representative of the electrical resistance of a current path through the electrolyte in which the first electrodes are immersed, from one major surface of the end electrode to the opposite major surface. It will be recalled that the first electrodes comprise sheets in the form of meshes, through which there will be this current path. The first first electrode electrolyte resistance Rₐ₁ is again fixed. The model also includes for the first end electrode a front surface resistance R_{f1} and a back surface resistance R_{b1}. The values of these resistances are variable, depending on the reactions at these surfaces. The values can be calculated from current-potential curves for the electrolyte in which the first electrodes are immersed.

Like the end electrode, the next first electrode in the array can be modelled by means of a second first electrode resistance Rₐ₂, a front surface resistance R_{f2} and a back surface resistance R_{b2}, and so forth up to the other end electrode and second electrode. With the resistance network, in particular the non-linear current-potential relations for the electrolyte at the first electrode surfaces, and Kirchhoff's rules, a non-linear system of equations can be created and solved, e.g. using a least-squared deviation fit solving strategy.

To obtain the appropriate resistance values of the pre-resistors, pre-resistor resistance values Rₚᵣₑ₁, Rₚᵣₑ₂ are added to the model in the branches representing the first electrodes. The currents through the individual first electrodes are calculated by solving the non-linear system of equations modified to reflect the added pre-resistors. This is repeated iteratively until an acceptable uniformity in value is achieved.

To simplify the calculations, values for a symmetrical apparatus such as the first apparatus 1 can be obtained by modelling only one half of the apparatus, up to a central one of the array of first electrodes. Also, it is possible to add only one pre-resistor, i.e. include only a pre-resistance value Rₚᵣₑ₁ for the end electrode.

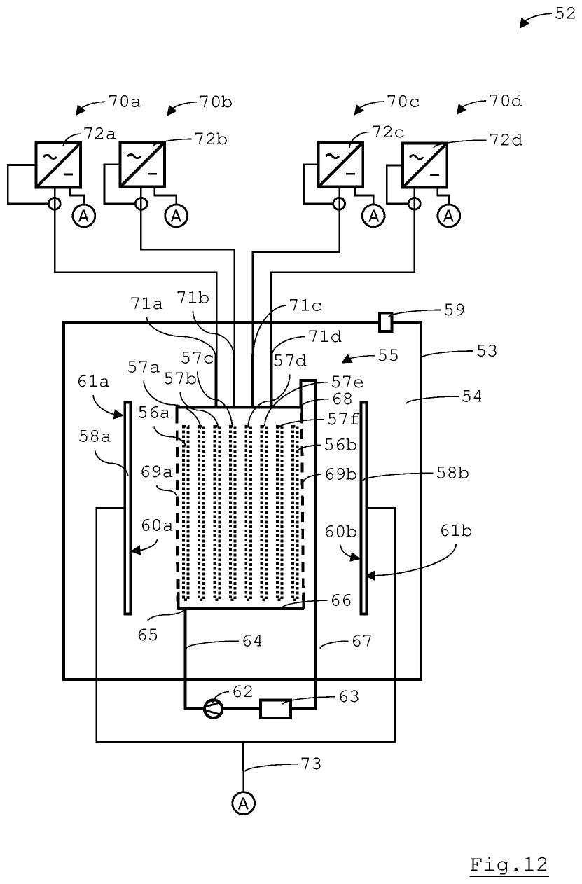

A second apparatus 52 (FIG. 12) for conducting an electrolytic process comprises a container 53 having a container interior 54. Disposed in the container interior 54 is an electrode unit 55 comprising an array of spaced-apart first electrodes, including two end electrodes 56a,b and, in this simplified example, six further first electrodes 57a-f. Also disposed in the container interior 54 are two second electrodes 58a,b. The second electrodes 58a,b are arranged to have an opposite polarity to that of the first electrodes 56a,b,57a-f, in use. The description of the second apparatus 52 will proceed on the basis that the second electrodes 58a,b function as cathodes. The first electrodes 56a,b,57a-f in the electrode unit 55 function as anodes.

The container 53 is provided with a fill opening 59 for filling the majority of a space in the container interior 54 surrounding the electrode unit 55 with a first electrolyte, also referred to herein as a catholyte.

In the filled state of the container interior 54, the second electrodes 58a,b are completely immersed in the catholyte, since the second electrodes 58a,b are completely exposed to the part of the container interior 54 surrounding the electrode unit 55.

The second electrodes 58 are planar, having a first major surface 60_{a,b} with a normal directed towards the electrode unit 55 and a second major surface 61_{a,b} having a normal extending in the opposite direction. The first electrodes 56a,b,57a-f are also planar, with the planes oriented generally in parallel to those of the second electrodes 58a,b.

The first electrodes 56a,b,57a-f are interposed between the second electrodes 58a,b. The end electrodes 56a,b have one major surface directed towards a proximal one of the second electrodes 58a,b. Each of the end electrodes 56_{a,b} is interposed between a proximal one of the two second electrodes 58_{a,b} and all of the further first electrodes 57a-f and the other end electrode 56a,b. The further first electrodes 57a-f each have at least one of the end electrodes 56a,b interposed between them and the second electrodes 58a,b.

The first electrodes 56a,b,57a-f each comprise a sheet in the form of a mesh, made of inert material, e.g. titanium, niobium, alloys thereof or carbon. In a particular embodiment, the mesh is an expanded metal mesh. The mesh may be coated, e.g. with a layer of platinum.

The second electrodes 58a,b may be provided in the form of sheets, each comprising a mesh. In alternative embodiments, they may be provided in the form of solid plates. The second electrodes 58a,b may be made of inert material, e.g. titanium, niobium, alloys thereof or carbon. The second electrodes 58a,b may alternatively be made of stainless steel.

A liquid-conducting circuit comprises a pump 62 and a reservoir 63, as well as an inlet conduit 64 connecting the pump 62 to a liquid inlet 65 of a housing 66 of the electrode unit 55 and an outlet conduit 67 leading from a liquid outlet 68 of the housing 66 back to the reservoir 63. Thus, a second electrolyte, also referred to herein as an anolyte, can be passed through the housing 66 of the electrode unit 55.

The first and second electrolyte may differ in terms of their composition, including the nature and/or relative proportions of their constituents. In an example, the first and second electrolytes both comprise phosphoric acid, but the second electrolyte additionally comprises silver ions, which act as a catalyst. The second electrolyte also comprises manganese species, including manganese oxide to be converted into manganese species having a higher oxidation number, e.g. permanganate ions, as part of a process of regenerating an etching solution. The regenerated solution is collected in the reservoir 63, from which this solution can be removed, in use.

The housing 66 of the electrode unit 55 comprises at least a section comprising one or more permselective membranes 69a,b allowing liquid to pass through, but forming a barrier to cations, or at least certain cation species.

A current supply system comprises a plurality of current sources 70a-d. There are four current sources 70a-d in the simplified illustrated embodiment. In the illustrated embodiment, the current sources 70a-d are controllable current sources.

Each of the current sources 70a-d is electrically connected in series via a respective current feeder 71a-d to a respective pair of first electrodes 56a,b,57a-f. The first electrodes 56a,b,57a-f are each connected to only one of the current sources 70a-d, so that the first electrodes 56a,b,57a-f form disjoint sub-sets of the complete set of first electrodes 56a,b,57a-f. Each sub-set comprises two first electrodes 56a,b,57a-f. The first electrodes 56a,b,57a-f of a pair are connected electrically in a parallel circuit with respect to each other, but in series with the current source 70. The electrodes in the sub-sets are arranged symmetrically with respect to a centre of the array of first electrodes 56a,b,57a-f in the illustrated embodiment. This need not be the case in variants of the illustrated embodiment.

The current sources 70a-d are arranged to be connected to the electrical grid (not shown), and therefore each comprise a rectifier 72a-d. The current supply system is arranged to cause electrical current to flow between the first electrodes 56a,b,57a-f of the electrode unit 55 on the one hand and the second electrodes 58a,b on the other, through the first and second electrolytes and a common electrical circuit section 73 external to the container 53.

The current sources 70a-d are set such that the currents flowing via the first electrodes 56a,b,57a-f differ only a little or not at all. This means that the current sources 70a-d establish potentials at major surfaces of the first electrodes 56a,b,57a-f that differ from one first electrode to the next, such that a differential to a potential of a most proximal one of the two second electrodes 58a,b increases according to how many of the first electrodes 56a,b,57a-f are interposed between the first electrode concerned and the most proximal second electrode 58a,b. Thus, the same effect is achieved as with the first apparatus 1, but without the use of pre-resistors.

The two ways of achieving this effect can be combined when the current sources 70a-d are not connected in series to a pair of the first electrodes 56a,b,57a-f arranged symmetrically about the centre of the array of first electrodes 56a,b,57a-f.

Although this is not shown in FIG. 12, the second electrodes 58a,b may be mounted to the housing 66 of the electrode unit 55 to form a cell for immersion in the container interior 54. The container interior 54 may thus have a relatively low volume.

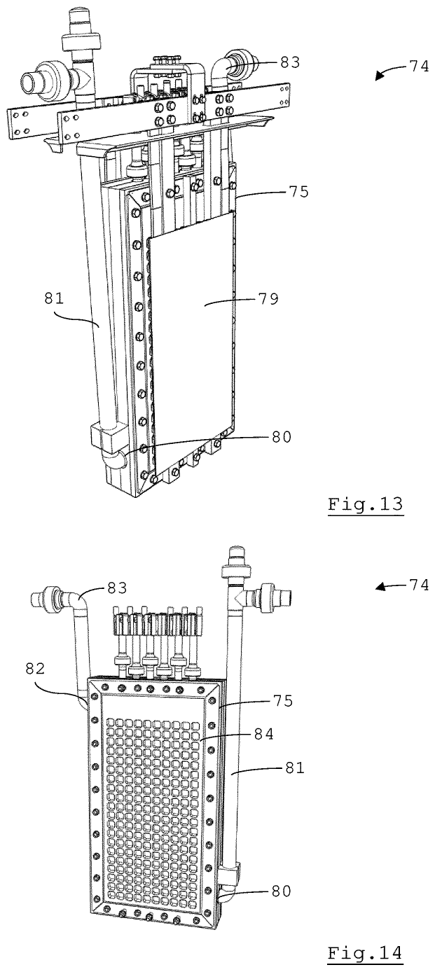

An example of such a cell 74 (FIGS. 13-17) is configured for use in an apparatus for conducting an electrolytic process such as the second apparatus 52.

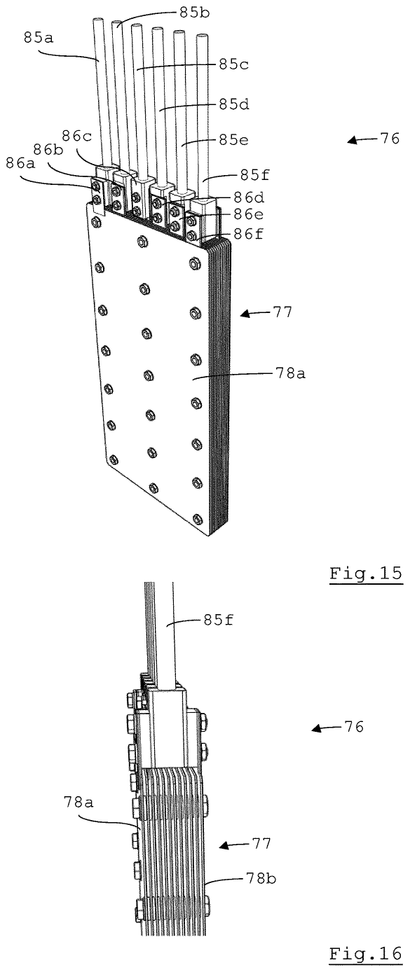

The cell 74 comprises a housing 75. The housing 75 at least partially, in this example only partially, encloses an electrode unit 76 (FIG. 15). The electrode unit 76 comprises a first electrode array 77, comprised of first electrodes which are electrically isolated from each other.

The first electrode array 77 comprises two end electrodes 78a,b, one at either end of the first electrode array 77. Further first electrodes are interposed between the end electrodes 78a,b. Each first electrode in the first electrode array 77 is provided in the form of a liquid-permeable sheet, in this example comprising a mesh, e.g. an expanded metal mesh. The first electrodes may comprise at at least their surfaces, e.g. only in surface coatings, at least one of lead, tantalum, platinum group metal or an alloy or oxide thereof. In an example, a surface coating is provided on a wire made of inert metal, e.g. titanium, niobium or carbon.

Identical second electrode assemblies (FIG. 13) are provided on opposite sides of the cell 74 (only one side is shown). These each comprise, in this example, a second electrode sheet 79, e.g. in the form of a mesh. The second electrode sheet 79 may be made of inert material, e.g. titanium, niobium, alloys thereof or carbon, or of stainless steel.

In use, each second electrode sheet 79 is connected to current sources such as the current sources 70a-d of the second apparatus 52.

The housing 75 is provided with a liquid inlet 80 for connecting an interior of the housing 75 to an inlet conduit 81. The housing 75 is also provided with a liquid outlet 82 for connecting the interior of the housing 75 to an outlet conduit 83. This enables an electrolyte, e.g. an anolyte, to be passed through the interior of the housing 75 in the manner described above in relation to the second apparatus 52.

The housing 75 is impermeable to liquid, but open at opposite ends. At each end, the housing 75 frames an opening in or against which a liquid-permeable spacer plate 84 (FIG. 14) is sealingly arranged. The spacer plate 84 is made of electrically insulating material. In the illustrated embodiment, the spacer plate 84 is provided with empty windows. In the illustrated embodiment, the windows are of equal size and shape and arranged in a regular grid.

The cell 74 comprises six current feeders 85a-f (FIG. 15) for connection in series to separate respective current sources (not shown) in the manner explained with reference to the second apparatus 52. The current feeders 85a-f extend through the housing 75. Seals ensure the separation of liquid between an interior of the housing 75 and an exterior is also maintained at this location. The current feeders 85a-f may be arranged in liquid-impermeable ducts to isolate them from electrolyte in which the cell 74 is immersed, in use.

Each current feeder 85 is connected to two first electrodes in the first electrode array 77 by means of electrically conducting sheets 86a-f and electrically conducting distance sheets 87a,b. The sheets 86a-f,87a,b may be made of inert material, e.g. titanium, niobium, alloys thereof or carbon.

In one embodiment, the first electrodes in the first electrode array 77 are separated by spacer disc arrays 88a-g, through which bolts in electrically insulating bushings are passed. It will be apparent that relatively many of these arrangements are required.

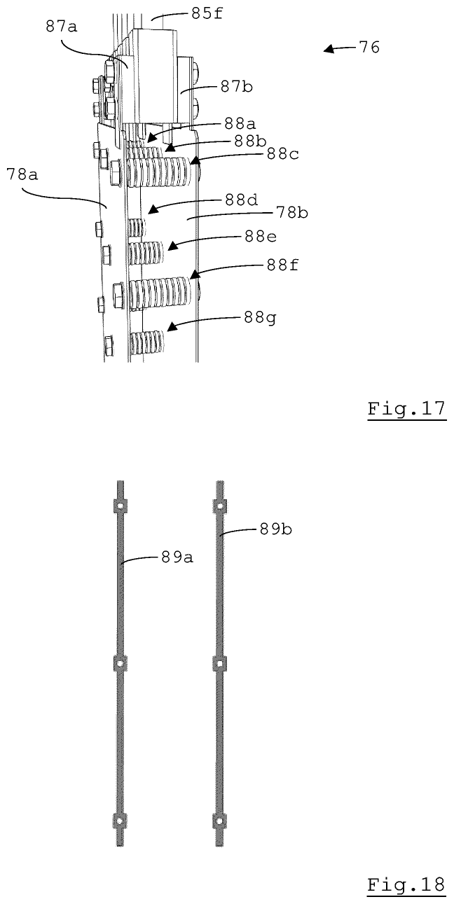

Alternatively or additionally, spacer strips 89 (FIG. 18) can be arranged between neighbouring first electrodes in the first electrode array 77. These extend over at least a majority of the largest dimension (in this case the height) of the first electrodes. Only three bolts in bushings are required to fix each spacer strip 89 in place, but they cover a relatively large area.

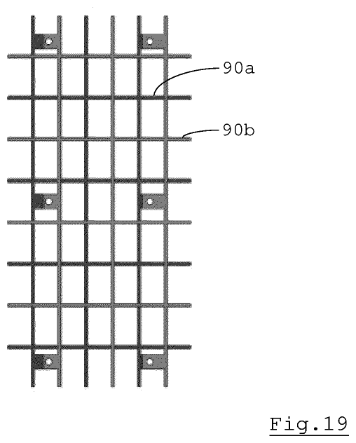

Another alternative is the use of spacer lattices 90a,b (FIG. 19), in this example two overlapping spacer lattices 90.

Alternatively or additionally, spacers in the form of threads of electrically insulating material can be used in the same manner as the threads 43a-c of the cell 23 of the embodiment with the pre-resistors. In that case, bolts are only required to immobilise the first electrodes of the first electrode array 77, not to fix the spacers. Furthermore, less electrode surface is covered by the spacers and the flow of electrolyte through the electrodes is relatively unobstructed compared to the spacer strips 89 or spacer lattices 90.

In all cases, spacers and bushings made of electrically insulating material may be made of polyvinylidene difluoride or polytetrafluoroethylene or another type of fluorinated polymer material. This applies also to the distance plates 31a-f of the cell 23 and the spacer plate 84 of the cell 74, for example. Metal parts coated with a polymer to make them electrically insulating—this applies, for example, to parts of the housing 75—may be coated with a polymer such as Ethylene-Chlortrifluorethylene (trade name: Halar).

Because neighbouring first electrodes in the first electrode array 77 are electrically isolated from each other and separate current sources are provided, potentials at corresponding locations on the major surfaces of the first electrodes can differ, such that the values of the electrical currents passing through them are more equal than would otherwise be the case. These values can all be set close to the level at which the reaction yield starts to level off and/or a risk of high wear at the surfaces becomes appreciable.

The spacers in the form of threads 43a-c allow for the use of relatively many first electrodes that are thin and positioned close together, whilst keeping the effort and number of parts needed to manufacture the first electrode arrays 26;77 within reasonable bounds.

The invention is not limited to the embodiments described above, which may be varied within the scope of the accompanying claims. For example, the electrical conductors that connect the first electrodes to the pre-resistor formation 33 may also have different electrical resistances and thus function as pre-resistors.

### List of Reference Numerals

1—1^{st} apparatus

2—container

3—container interior

4—electrode unit

5a,b—end electrodes

6a-d—further first electrodes

7a,b—second electrodes

8—fill opening

9a,b—first major surface

10a,b—second major surface

11—pump

12—reservoir

13—inlet conduit

14—liquid inlet

15—electrode unit housing

16—outlet conduit

17—liquid outlet

18a,b—Membranes

19—current source

20—rectifier

21 external electrical circuit section

22a,b—current feeders

23—cell

24—housing

25—electrode unit

26—first electrode array

27—liquid inlet

28—inlet conduit

29—liquid outlet

30—outlet conduit

31a,b—distance plates

32a,b—current feeders

33—pre-resistor formation

34a,b—support plate

35a,b—first electrical contact points

36a-n—current paths

37a-n—second electrical contact point

38a,b—central first electrodes

39a,b—electrode contact points

40a-l—bushings

41a-d—disc arrays

42—exemplary first electrode

43a,b—threads

44a-e—stitches

45a-c—sequence paths

46a-l—bushing apertures

47a,b—exemplary electrode contact points

48—major section

49—pre-resistor section

50—contact point

51—model current source

52—second apparatus

53—container

54—container interior

55—electrode unit

56a,b—end electrodes

57a-f—further first electrodes

58a,b—second electrodes

59—fill opening

60a,b—first major surfaces

61a,b—second major surfaces

62—pump

63—reservoir

64—inlet conduit

65—liquid inlet

66—housing

67—outlet conduit

68—liquid outlet

69a,b—membranes

70a-d—current sources

71a-d—current feeders

72a-d—rectifiers

73—external electrical circuit section

74—cell

75—housing

76—electrode unit

77—first electrode array

78a,b—end electrodes

79—second electrode sheet

80—liquid inlet

81—inlet conduit

82—liquid outlet

83—outlet conduit

84—spacer plate

85a-f—current feeders

86a-f—electrically conducting sheets

87a,b—distance sheets

88a-g—spacer disc arrays

89a,b—spacer strips

90a,b—spacer lattices

1. Apparatus for conducting an electrolytic process, comprising:
a container (2;53) having a container interior (3;54) for accommodating at least one electrolyte;
an array (26;77) of spaced-apart first electrodes (5a,b,6a-d;38a,b,42;56a,b,57a-f;78a,b), arranged in the container (2;53);
at least one second electrode (7a,b;58a,b;79), arranged with at least part of a surface thereof exposed to at least part of the container interior (3;54) for accommodating at least one of the at least one electrolytes; and
a current supply system for causing electrical current to flow via the second electrode(s) (7a,b;58a,b;79) and major surfaces of the first electrodes (5a,b,6a-d;38a,b,42;56a,b,57a-f;78a,b) through the at least one electrolyte by establishing potential differences between major surfaces of the first electrode (5a,b,6a-d;38a,b,42;56a,b,57a-f;78a,b) on the one hand and the second electrodes (7a,b;58a,b;79) on the other hand, such that the first electrodes (5a,b,6a-d;38a,b,42;56a,b,57a-f;78a,b) have an opposite polarity to the polarities of the second electrodes (7a,b;58a,b;79),
wherein the array (26;77) of first electrodes (5a,b,6a-d;38a,b,42;56a,b,57a-f;78a,b) includes at least one end electrode (5a,b;56a,b;78a,b) interposed between one of the second electrodes (7a,b;58a,b;79) and all of the other first electrodes (6a-d;38a,b,42;57a-f) of the array (26;77) on the other hand, and
wherein, in addition to the end electrode(s) (5a,b;56a,b;78a,b), the array (26;77) of first electrodes includes at least one first electrode (6a-d;38a,b,42;57a-f) other than an end electrode (5a,b;56a,b;78a,b), wherein
the apparatus is configured to establish potentials at the major surfaces of at least the end electrode(s) (5a,b;56a,b;78a,b) that differ from those at the major surfaces of the first electrodes (6a-d;38a,b,42;57a-f) in the array (26;77) other than the end electrode(s) (5a,b;56a,b;78a,b) by being closer to respective potentials of the second electrode(s) (7a,b;58a,b;79).

2. Apparatus according to claim 1,
wherein the current supply system comprises at least two electrical current sources (70a-d), each electrically connected in series via respective electrical current feeders (71a-d;85a-f) to respective disjoint sub-sets of the first electrodes (56a,b,57a-f;78a,b) in the array (77).

3. Apparatus according to claim 1,
wherein at least two of the first electrodes (5a,b,6a-d;38a,b,42) are connected electrically in series with a common electrical current source (19) comprised in the current supply system,
wherein pre-resistors are arranged electrically between the major surfaces of the first electrodes (5a,b,6a-d;38a,b,42) electrically connected to the common electrical current source (19), and
wherein total resistance values of the pre-resistors between the common electrical current source (19) and the first electrode (5a,b,6a-d;38a,b,42) differ between the first electrodes (5a,b,6a-d;38a,b,42) connected to the common electrical current source (19) such as to decrease according to how many of the first electrodes (5a,b,6a-d;38a,b,42) are interposed in the array (26) between the first electrode (5a,b,6a-d;38a,b,42) and a most proximal one of the at least one second electrodes (7a,b).

4. Apparatus according to claim 3,
wherein the first electrodes (5a,b,6a-d;38a,b,42) connected electrically in series with a common electrical current source (19) are connected in a parallel circuit with respect to each other and the pre-resistors are arranged in respective branches of the parallel circuit in which the first electrodes are comprised, so that the total resistance values of the pre-resistors differ between the branches to decrease according to how many of the first electrodes (5a,b,6a-d;38a,b,42) are interposed in the array (26) between the first electrode (5a,b,6a-d;38a,b,42) in the branch and a most proximal one of the at least one second electrodes (7a,b).

5. Apparatus according to claim 3,
wherein the first electrodes (5a,b,6a-d;38a,b,42) are provided in the form of sheets, comprising at least a major section (48) defining the major surfaces, and
wherein the sheet forming at least one of the first electrodes (5a,b,6a-d;38a,b,42) further comprises at least one section (49) forming one of the pre-resistors and interconnecting the major section (48) with at least one contact point (50) electrically connecting the first electrode (5a,b,6a-d;38a,b,42) to a remainder of the circuit in which the first electrode (5a,b,6a-d;38a,b,42) is comprised.

6. Apparatus according to claim 3,
further comprising at least one pre-resistor formation (33),
wherein the pre-resistor formation (33) is provided with at least one first electrical contact point (35a,b) electrically connected to an electrical current source (19) comprised in the current supply system and with a plurality of second electrical contact points (37a-n),
wherein at least two of the second electrical contact points (37a-n) are electrically connected to different respective first electrodes (5a,b,6a-d;38a,b,42), and
wherein current paths (36a-n) of different electrical resistance are formed in the pre-resistor formation (33) between at least one of the at least one first electrical contact points (35a,b) and second electrical contact points (37a-n) electrically connected to different respective first electrodes (5a,b,6a-d;38a,b,42).

7. Apparatus according to claim 6,
wherein each of at least one of the first electrodes (5a,b,6a-d;38a,b,42) is electrically connected to at least two of the second electrical contact points (37a-n) through respective electrical conductors connected to spaced-apart electrical contact points (39a,b,47a,b) of that first electrode (5a,b,6a-d;38a,b,42).

8. Apparatus according to claim 6,
wherein the pre-resistor formation (33) comprises a sheet with mutually separated current paths (36a-n) formed therein, wherein the current paths (36a-n) of different electrical resistance differ in terms of at least one of length and cross-sectional area perpendicular to a direction of progression of the current path (36a-n) along the length of the current path (36a-n).

9. Apparatus according to claim 8,
wherein the pre-resistor formation (33) is interposed between two of the first electrodes (5a,b,6a-d;38a,b,42) in the array (26).

10. Apparatus according to claim 1,
wherein the first electrodes (5a,b,6a-d;38a,b,42;56a,b,57a-f;78a,b) are provided in the form of liquid-permeable sheets.

11. Apparatus according to claim 10,
wherein at least two neighbouring first electrodes (5a,b,6a-d;38a,b,42;56a,b,57a-f;78a,b) are separated from each other by at least one spacer (41a-d;43a-c;88a-g;89a,b;90a,b).

12. Apparatus according to claim 10,
wherein the sheets comprise meshes.

13. Apparatus according to claim 11,
wherein the sheets comprise meshes,
wherein the spacer comprises a thread (43a-c) of material having a lower electrical conductivity than material from which the meshes are made, and
wherein the thread (43a-c) is threaded through at least one of the meshes comprised in the neighbouring first electrodes (5a,b,6a-d;38a,b,42;56a,b,57a-f;78a,b) in the form of a sequence (45a-c) of stitches (44a-e).

14. Method of conducting an electrolytic process using an apparatus, according to any one of the claim 1, comprising:
providing a container (2;53) having a container interior (3;54) for accommodating at least one electrolyte;
an array (26;77) of spaced-apart first electrodes (5a,b,6a-d;38a,b,42;56a,b,57a-f;78a,b), arranged in the container (2;53); and
at least one second electrode (7a,b;58a,b;79), arranged with at least part of a surface thereof exposed to at least part of the container interior (3;54) for accommodating at least one of the at least one electrolytes,
wherein the array (26;77) of first electrodes (5a,b,6a-d;38a,b,42;56a,b,57a-f;78a,b) includes at least one end electrode (5a,b;56a,b;78a,b) interposed between one of the second electrodes (7a,b;58a,b;79) and all of the other first electrodes (6a-d;38a,b,42;57a-f) of the array (26;77), and
wherein, in addition to the end electrode(s) (5a,b;56a,b;78a,b), the array (26;77) of first electrodes (5a,b,6a-d;38a,b,42;56a,b,57a-f;78a,b) includes at least one first electrode (6a-d;38a,b,42; 57a-f) other than an end electrode (5a,b;56a,b;78a,b),
wherein the method comprises:
providing the at least one electrolyte in the container (2;53); and
causing electrical current to flow via the second electrode(s) (7a,b;58a,b;79) and major surfaces of the first electrodes (5a,b,6a-d;38a,b,42;56a,b,57a-f;78a,b) through the at least one electrolyte by establishing potential differences between major surfaces of the first electrode (5a,b,6a-d;38a,b,42;56a,b,57a-f;78a,b) and the second electrodes (7a,b;58a,b;79) such that the first electrodes (5a,b,6a-d;38a,b,42;56a,b,57a-f;78a,b) have an opposite polarity to the polarities of the second electrodes (7a,b;58a,b;79),
wherein
the step of causing electrical current to flow comprises establishing potentials at the major surfaces of least the end electrode(s) (5a,b;56a,b;78a,b) that differ from those at the major surfaces of the first electrodes (6a-d;38a,b,42;57a-f) in the array (26;77) other than the end electrode(s) (5a,b;56a,b;78a,b) by being closer to respective potentials of the second electrode(s) (7a,b;58a,b;79).

15. Method according to claim 14,
wherein ions, in at least one of the at least one electrolytes are electrolytically oxidised, as a step in a process of at least partly regenerating an etching solution.

16. Method according to claim 15,
wherein the ions comprise manganese species.

17. Method according to claim 14,
wherein (i) the array of first electrodes is at least partially enclosed by a housing, the second electrode(s) is or are arranged outside the housing, and the housing comprises at least one permselective membrane separating an interior of the housing from an exterior of the housing, and, but for the at least one permselective membrane(s), the housing is arranged to provide a separation of liquid in the interior of the housing from the exterior of the housing; or
ii) the array of first electrodes is at least partially enclosed by a housing arranged to provide a separation of liquid in an interior of the housing from an exterior of the housing, and the at least one second electrodes are attached to the housing such that at least one section of each of the second electrodes is exposed to the interior of the housing, the method further comprises passing electrolyte through the interior of the housing.

18. Apparatus according to claim 1,
wherein the apparatus is used in re-generating of the at least one electrolyte by electrochemically oxidising at least one constituent of the solution.

19. Apparatus according to claim 18,
wherein the at least one electrolyte is an etching solution.

20. Apparatus according to claim 19,
wherein the etching solution comprises manganese species to be electrochemically re-oxidised.
